(19) United States
(12) Patent Application Publication
(10) Pub. No.: US 2009/0213771 A1
(43) Pub. Date: Aug. 27, 2009

(54) FORWARDING IN DISTRIBUTED WIRELESS NETWORKS

(75) Inventors: Ulrico Celentano, Oulu (FI); Harald Kaaja, Jarvenpaa (FI); Juha Salokannel, Tampere (FI)

Correspondence Address: Locke Lord Bissell & Liddell LLP;Attn: IP Docketing, Three World Financial Center, New York, NY, 10281-2101, US

(73) Assignee: Nokia Corporation, Espoo (FI)

(21) Appl. No.: 12/036,792

(22) Filed: Feb. 25, 2008

(51) Int. Cl. H04B 7/00

(52) U.S. Cl. 370/310

(57) ABSTRACT

A method, system, and computer program product are disclosed for providing a forwarding feature in the WiMedia MAC communication protocol or in other suitable communication protocols. The method enables a forwarder device to indicate its capability to operate as a forwarder device in its beacon transmissions and to enable an initiating device to utilize the forwarder device for communicating data and/or network control information to destination devices that can be accessed through the forwarder device over two or more hops.

### FIELD

The technical field relates to wireless communications. More particularly, the technical field relates to techniques for forwarding information in wireless network environments.

### BACKGROUND

The seven layers of the Open Systems Interconnection Basic Reference Model (OSI Model) are, from top to bottom, the Application layer 7, the Presentation layer 6, the Session layer 5, the Transport layer 4, the Network layer 3, the Data Link layer 2, and the Physical layer (PHY) 1. The Medium Access Control (MAC) sub-layer is part of the Data Link layer 2.

The WiMedia Ultra-Wideband (UWB) Common Radio Platform incorporates high rate physical layer (PHY) techniques for short-range proximity networks. It involves frequency hopping applications of orthogonal frequency division multiplexing (OFDM). This technique involves the transmission of OFDM symbols at various frequencies according to pre-defined codes, such as Time Frequency Codes (TFCs). Time Frequency Codes can be used to spread interleaved information bits across a larger frequency band. The WiMedia Ultra-Wideband (UWB) Common Radio Platform incorporates media access control (MAC) layer and physical (PHY) layer specifications based on Multi-band Orthogonal Frequency Division Multiplexing (MB-OFDM). The WiMedia UWB enables short-range multimedia file transfers at high data rates with low energy consumption, and operates in the 3.1 to 10.6 GHz UWB spectrum. The WiMedia Alliance has developed an OFDM physical layer described in ECMA-368 and ISO/IEC-26907. These documents are incorporated herein by reference in their entirety.

The WiMedia Medium Access Control (MAC) group has developed a Medium Access Control (MAC) layer that can be used with an OFDM physical layer, such as the WiMedia PHY, which is described in ECMA-368 and ISO/IEC-26907. These documents are incorporated herein by reference in their entirety and their subject matter is referred to herein as WiMedia.

This MAC layer involves a group of wireless communications devices, referred to as a beacon group, which are capable of communicating with each other. The timing of beacon groups is based on a repeating pattern of superframes in which the devices may be allocated communications resources. These communications resources may be in the form of one or more time slots, referred to as media access slots (MASs).

MAC layers govern the exchange among devices of transmissions called frames. A MAC frame may have various portions, including frame headers and frame bodies. A frame body includes a payload containing data associated with higher protocol layers, such as user applications. Examples of such user applications include web browsers, e-mail applications, messaging applications, and the like.

In addition, MAC layers govern the allocation of resources. For instance, each device requires an allocated portion of the available communication bandwidth to transmit frames. The WiMedia MAC provides for the allocation of resources to be performed through beacons. Beacons are transmissions that devices use to convey control information. Each device in a beacon group is assigned a portion of bandwidth to transmit beacons.

Each superframe starts with a beacon period (BP), which has a maximum length of a specified number of beacon slots. The length of each beacon slot is also specified. Beacon slots in the beacon period (BP) are numbered in sequence, starting at zero. The first few beacon slots of a beacon period (BP) are referred to as signaling slots and are used, for example, to extend the BP length of neighbors. An active mode device transmits and receives beacons. When transmitting in a beacon slot, a device starts transmission of the frame in the medium at the beginning of that beacon slot. A device transmits beacons at a specified rate. The transmission time of beacon frames does not exceed a specified duration, which allows for a guard time of at least a specified duration between the end of a beacon and the start of the next beacon slot.

Such transmissions allow the WiMedia MAC to operate according to a distributed control approach, in which multiple devices share MAC layer responsibilities. Accordingly, the WiMedia MAC Specification provides various channel access mechanisms that allow devices to allocate portions of the transmission medium for communications traffic. These mechanisms include a protocol called the distributed reservation protocol (DRP) in which reservations for connections are negotiated by exchanging beacons among devices. These mechanisms also include a protocol called prioritized contention access (PCA).

The distributed reservation protocol (DRP) enables devices to reserve one or more media access slots (MASs) that the device can use to communicate with one or more neighbors. All devices that use the distributed reservation protocol (DRP) for transmission or reception announce their reservations by including DRP information elements (IEs) in their beacons. A reservation is the set of MASs identified by DRP IEs with the same values in the Target/Owner DevAddr, Owner, and Reservation Type fields. Reservation negotiation is always initiated by the device that will initiate frame transactions in the reservation, referred to as the reservation owner. The device that will receive information is referred to as the reservation target. A reservation defined by DRP IEs with the Owner/Target DevAddr field set to a multicast address (McstAddr) and the Owner bit set to one is referred to as a multicast reservation. A reservation defined by DRP IEs with the Owner bit set to zero and made in response to a multicast reservation is also referred to as a multicast reservation.

The WiMedia PHY provides for various channels across a frequency range. These channels are referred to as logical channels. Each logical channel employs a different Time Frequency Code (TFC). As discussed above, TFCs specify a repeating time sequence in which various frequency bands within a frequency range are used. Thus, a device employing a TFC transmits at different frequencies at particular times specified by the TFC. Currently, the WiMedia PHY specifies each band having a 528 MHz bandwidth. These bands are within the frequency operating range of between 3.1 and 10.6 GHz.

A problem in the art is how to route and forward data over two or more hops in wireless networks using the WiMedia Ultra-Wideband (UWB) Common Radio Platform, where the initiating device and the destination device are not able to communicate, either because the destination device is in hibernation mode, or they are blocked in one or both directions by an obstruction, or they are separated too far from one another. In networks using Transmission Control Protocol (TCP)/Internet Protocol (IP), the IP Network layer 3 performs network routing, sending data in multiple hops from an initiating device to a destination device via one or more intermediate routers in the network. However, there is a fairly substantial overhead in using the Network layer 3 to route data in multiple hops, which unnecessarily impairs the speed and energy efficiency of packet forwarding operations. What is needed is an alternative to layer-3 routing, which can forward data over two or more hops using the MAC sub-layer of the Data Link layer 2 of the WiMedia Ultra-Wideband (UWB) Common Radio Platform.

### SUMMARY

A method, apparatus, system, and computer program product are disclosed for providing a forwarding feature in the WiMedia MAC communication protocol or in other suitable communication protocols. The method enables a forwarder device to indicate its capability to operate as a forwarder device in its beacon transmissions and to enable an initiating device to utilize the forwarder device for communicating data to destination devices that can be accessed through the forwarder device over two or more hops. The method solves the problem of routing or forwarding data in wireless networks over two or more hops, where the initiating device and the destination device are not in communications range, either because the destination device in hibernation mode, the initiating and destination devices they are blocked in one or both directions by an obstruction, or they are too far removed from one another.

In an example embodiment, the method includes receiving information from a wireless device including an indication of the wireless device's capability to forward data within a network, the information further including descriptive information regarding at least one other wireless device in the network accessible through the wireless device and the further step of determining whether to wirelessly transmit data to the wireless device, for forwarding the data to the at least one other wireless device based on the received information. In another example embodiment, the computer program product includes a computer readable medium having computer program code therein to perform the method. In another example embodiment, the apparatus includes a memory configured to receive information from a wireless device including an indication of said wireless device's capability to forward data within a network, said information further including descriptive information regarding at least one other wireless device in the network accessible through the wireless device and a processor coupled to the memory, configured to determine whether to wirelessly transmit data to said wireless device, for forwarding said data to the at least one other wireless device based on said received information.

In a further example embodiment, the method includes transmitting, by a wireless device, a beacon message during a dedicated portion of a repeating time period allocated for beacon transmissions for maintaining coordination with one or more other wireless devices within a network, wherein the beacon message includes an indication of the wireless device's capability to forward data within the network. In another example embodiment, the computer program product includes a computer readable medium having computer program code therein to perform the method. In another example embodiment, the apparatus includes a processor configured to collect in a wireless device, information of a plurality of neighbor wireless device in a network and a transmitter coupled to the processor, configured to transmit a beacon message during a dedicated portion of a repeating time period allocated for beacon transmissions for maintaining coordination with one or more other wireless devices within a network, wherein the beacon message includes an indication of the wireless device's capability to forward the information within the network.

In another example embodiment, the method includes an initiating device receiving hibernation information descriptive of a destination device in a wireless network, the hibernation information having been directly received by the initiating device or having been sent by another device that collected the information in the network. The method continues by the initiating device determining whether to wirelessly transmit data to the forwarder device, for the purpose of forwarding the data to the destination device, based on whether the hibernation information indicates that the destination device is currently hibernating.

In another example embodiment, the method further includes receiving in the forwarder device a request beacon from the initiating device requesting that a delegated beacon to be built by the forwarder device based on the original beacon it previously received from the initiating device. The method includes the step of collecting in the forwarder wireless device, hibernation information of a plurality of neighbor wireless devices in the network, including the destination device. The capability information can also include link quality, hibernation schedule, and reserve energy information associated with the respective neighbor devices that may be potential forwarder devices. The method further includes receiving in the forwarder device from the initiating wireless device, a request for capability information describing the capability of the forwarder device to wirelessly communicate with the destination wireless device. The method further includes transmitting to the initiating device the capability information based on the hibernation information. The method further includes receiving in the forwarder device an original beacon from the initiating device intended to be received by the destination device. The destination device, in this example, does not receive the original beacon, either because it has been corrupted by interference or it is missed altogether. The initiating device learns of the failure of the destination device to receive the original beacon. The method further includes receiving in the forwarder device a request from the initiating device to forward delegated beacon information based on the original beacon, to the destination device. The method further includes building in the forwarder device the delegated beacon information based on the original beacon. The forwarder device proceeds to build the delegated beacon information based on the original beacon. Then, the method forwards the delegated beacon information to the destination device. The delegated beacon information can be sent in a beacon slot currently assigned to the forwarder device, or in a second beacon slot of two beacon slots assigned to the forwarder device, or in a data transfer period reserved by the forwarder device. The capability information can further include a link quality with the destination device, overlapped active time with the destination device, and residual energy information.

In another example embodiment, the method further includes the initiating device sending a request to the forwarder device, to forward delegated beacon information of the initiating device to a destination device in the network, the forwarder device then forwarding to the destination device delegated beacon information based on the beacon information received from the initiating device, but whose format depends on the specific forwarding method used by the forwarder device.

In another example embodiment, the method further includes load balancing for the data forwarding process. The method includes the initiating device distributing its forwarding beacon request to several devices in the beacon group, which are connected in both directions with the initiating device and the destination device, to act as data forwarder devices. The proportion of the forwarded traffic that the initiating device allocates to each accepting forwarder device can be based, for example, on the link quality, buffer size, overlapped active time, residual battery energy, or other factors that each respective forwarder device reports as its capability to forward information to the destination device.

In still another example embodiment, the method includes information collector wireless devices, such as the forwarder device, collecting hibernation information, link quality information, and residual battery energy of a plurality of neighbor wireless devices in a network that may be potential forwarder devices. The forwarder device then receives from the initiating device, a request for capability information describing the capability of the forwarder device to wirelessly communicate with a destination device of the plurality of neighbor wireless devices. The forwarder device transmits to the initiating device the capability information. The method further includes the forwarder device receiving from the initiating device, a beacon requesting a forwarding of data from the initiating device to the destination device, and the forwarder device further receiving the data from the initiating device and forwarding the data to the destination wireless device.

The method further includes the forwarder device receiving from the initiating device a request beacon that refers to beacon information of the initiating device, the request beacon requesting the building of delegated beacon information and forwarding it to the destination device, the forwarder device then building and forwarding the delegated beacon information based on beacon information received from the initiating device, but whose format depends on the specific forwarding method used by the forwarder device.

The various steps can, for example, be performed under control of a medium access control (MAC) layer in the respective wireless devices. The medium access control (MAC) layer, for example, can be a sub-layer of a Data Link layer of a WiMedia Ultra-Wideband (UWB) Common Radio Platform.

As a result of the example embodiments of the invention, data can be forwarded over two or more hops in wireless networks using the WiMedia MAC communication protocol, where the initiating device and the destination device are not able to communicate, either because the destination device is in hibernation mode, or they are blocked in one or both directions by an obstruction, or they are too far removed from one another. The example embodiments of the invention replace the data forwarding functions of the OSI Network level 3 with the forwarding functions that the example embodiments incorporate into the Data Link layer 2 WiMedia MAC protocol. WiMedia devices in the example embodiments of the invention can perform multiple-hop data forwarding without requiring the OSI Network level 3 protocol on top of the Data Link layer 2 WiMedia MAC protocol, thereby simplifying the WiMedia devices.

### DESCRIPTION OF THE FIGURES

FIG. 1A is an example physical view of a network of wireless devices in Beacon Group G1, which includes devices A1, A2, A3, A4, A5 that are in the active mode and devices Hib1 to Hib11 that are in the hibernation mode. Active Device A6 is also shown, which has recently drifted out of the range of Beacon Group G1.

FIG. 1B is an example view of only the active devices in the Beacon Group G1 of FIG. 1A.

FIG. 1C illustrates an external view and a functional block diagram of an example embodiment of any of the wireless devices of FIG. 1A, such as device A1.

FIG. 2 illustrates an example superframe format with beacons of the active devices A1, A2, A3, A4, A5 transmitted in the beacon period of each superframe 102A, 102B, and 102C.

FIGS. 2A, 2B, and 2C show three examples of beacon frames from the initiating device A1 with Forwarding Request information elements (IE) in the beacon frame.

FIG. 2D shows an example view the active devices in the Beacon Group G1 of FIG. 1A, with initiating device A1 sending a beacon frame 200E to the forwarder device A4 to request A4 to forward data to the currently hibernating destination device Hib8 after Hib8 emerges from its hibernation mode.

FIG. 2E shows an example of the initiating device A1's beacon frame 200E in FIG. 2D.

FIG. 2F shows an example view the active devices in the Beacon Group G1 of FIG. 1A, with initiating device A1 sending a data frame 200G to the forwarder device A4.

FIG. 2G shows an example of the initiating device A1's data frame 200G in FIG. 2F, conveying the data to the forwarder device A4.

FIG. 2H shows an example view the active devices in the Beacon Group G1 of FIG. 1A, with forwarder device A4 sending a beacon frame 200_I to the destination device Hib8 after Hib8 emerges from its hibernation mode.

FIG. 2I shows an example of the forwarder device A4's beacon frame 200_I in FIG. 2H.

FIG. 2J shows an example view the active devices in the Beacon Group G1 of FIG. 1A, with forwarder device A4 sending a data frame 200K to the destination device Hib8 after Hib8 emerges from its hibernation mode.

FIG. 2K shows an example of the forwarder device A4's data frame 200K in FIG. 2J, conveying the data to the destination device Hib8 after Hib8 emerges from its hibernation mode.

FIG. 3A shows an example of a beacon frame from the forwarder device A4 with a Forwarding Capability information element (IE) in the beacon frame responding to device A1's request for the capability of device A4 to forward data to device Hib8.

FIG. 3B shows an example of a beacon frame from the forwarder device A4 with a proactive Forwarding Capability information element (IE) to spontaneously broadcast to all devices indicating the capability of device A4 to forward data to device Hib8.

FIG. 3C shows an example of a beacon frame from the forwarder device A4 with a Forwarding Capability information element (IE) to spontaneously broadcast to all devices providing the neighbor table of device A4 for all neighboring devices to device A4.

FIG. 4A shows an example of a neighbor table for device A4 in local survey cache 402A in the memory of device A4.

FIG. 4B shows an example of a neighbor table for device A5 in local survey cache 402B in the memory of device A5.

FIG. 4C shows an example of a remote device neighbor reports cache 404 in the memory of device A1, which has received and stored copies of the neighbor table for device A4 and the neighbor table for device A5.

FIG. 5A shows an example view the active devices in the Beacon Group G1 of FIG. 1A, with initiating device A1 sending a delegated beacon request to forwarder device A4, requesting that a delegated beacon to be built by the forwarder device A4 based on the original beacon it previously received from the initiating device A1, to send to destination device A5, because of an obstruction blocking direct communication in either direction between initiating device A1 and destination device A5.

FIG. 5B shows an example of a beacon from initiating device A1 to forwarder device A4 in FIG. 5A, to enable device A1 to send a delegated beacon request to device A4 for building the delegated beacon to send to destination device A5.

FIG. 5C shows an example view the active devices in the Beacon Group G1 of FIG. 5A, with forwarder device A4 sending to destination device A5, the delegated beacon information it has built based on the original beacon it previously received from the initiating device A1, because of the obstruction blocking direct communication both ways between device A1 and device A5.

FIG. 5D shows an example of a beacon from forwarder device A4 to destination device A5 in FIG. 5C, to enable device A4 to forward the delegated beacon information to device A5.

FIG. 5E shows an example view the active devices in the Beacon Group G1 of FIG. 1A, with device A5 optionally responding by sending a delegated beacon request to forwarder device A4, requesting that a delegated beacon to be built by the forwarder device A4 based on an original beacon it previously received from the device A5, to send to device A1, because of the obstruction blocking direct communication in either direction between device A1 and device A5.

FIG. 5F shows an example view the active devices in the Beacon Group G1 of FIG. 5E, with forwarder device A4 sending to device A1, the delegated beacon information it has built based on the original beacon it previously received from the device A5, because of the obstruction blocking direct communication both ways between device A1 and device A5.

FIG. 5G shows an example of a beacon from forwarder device A4 to destination device A5 in FIG. 5C, wherein the delegated beacon information is forwarded by device A4 within the same beacon slot, embedded in device A4's own beacon.

FIG. 5H shows an example of a beacon from forwarder device A4 to destination device A5 in FIG. 5C, wherein the delegated beacon information is forwarded by device A4 in a new, dedicated beacon slot.

FIG. 5I shows an example of a beacon from forwarder device A4 to destination device A5 in FIG. 5C, wherein the delegated beacon information is forwarded by device A4 in the data transfer period (DTP).

FIG. 6A shows an example view the active devices in the Beacon Group G1 of FIG. 1A, with device A1 sending a delegated beacon request to device A4 for forwarding the delegated beacon information to device A5, because of an asymmetric link which is only good for transmissions from device A5 to device A1, but is not good for transmissions from device A1 to device A5.

FIG. 6B shows an example view the active devices in the Beacon Group G1 of FIG. 6A, with device A4 forwarding the delegated beacon information to device A5, because of the asymmetric link blocking direct transmissions from device A1 to device A5.

FIG. 6C shows an example view the active devices in the Beacon Group G1 of FIG. 6A, where device A5, optionally, may directly transmit its response to device A1 with A5's own beacon, because the asymmetric link is only good for transmissions from device A5 to device A1.

FIG. 7 is an example flow diagram of an example embodiment, for receiving in an initiating device, hibernation information of a destination wireless device and determining whether to send data to a forwarder device for forwarding the data to the destination wireless device, based on the hibernation information.

FIG. 8 is an example flow diagram of an example embodiment, for sending from an initiating device a request to a forwarder device to forward delegated beacon information to a destination wireless device.

FIG. 9 is an example flow diagram of an example embodiment, for collecting in a forwarder device, hibernation information and link quality information of a plurality of neighbor wireless devices in a network.

FIG. 10A is an example flow diagram of an example embodiment, for receiving in a forwarder device, a request beacon requesting a forwarding of delegated beacon information to a destination device.

FIG. 10B is an example flow diagram of an example embodiment, for receiving a request beacon requesting forwarding of delegated beacon information to be built by the forwarder device based on the original beacon received from the initiating device.

FIG. 10C is an example flow diagram of an example embodiment, for load balancing in the data forwarding process.

FIG. 11 is an example sequence diagram of an example embodiment, for a forwarding-capable device to automatically collect its neighbor's link quality indicators and hibernation status from their respective beacons.

FIG. 12 is an example sequence diagram of an example embodiment, for a forwarding-capable device to collect its neighbor's link quality indicators and hibernation status from their respective beacons on request from another device.

FIG. 13 is an example sequence diagram of an example embodiment, where a device recognizes that another device is reachable by forwarding data over a forwarder device.

### DISCUSSION OF EXAMPLE EMBODIMENTS OF THE INVENTION

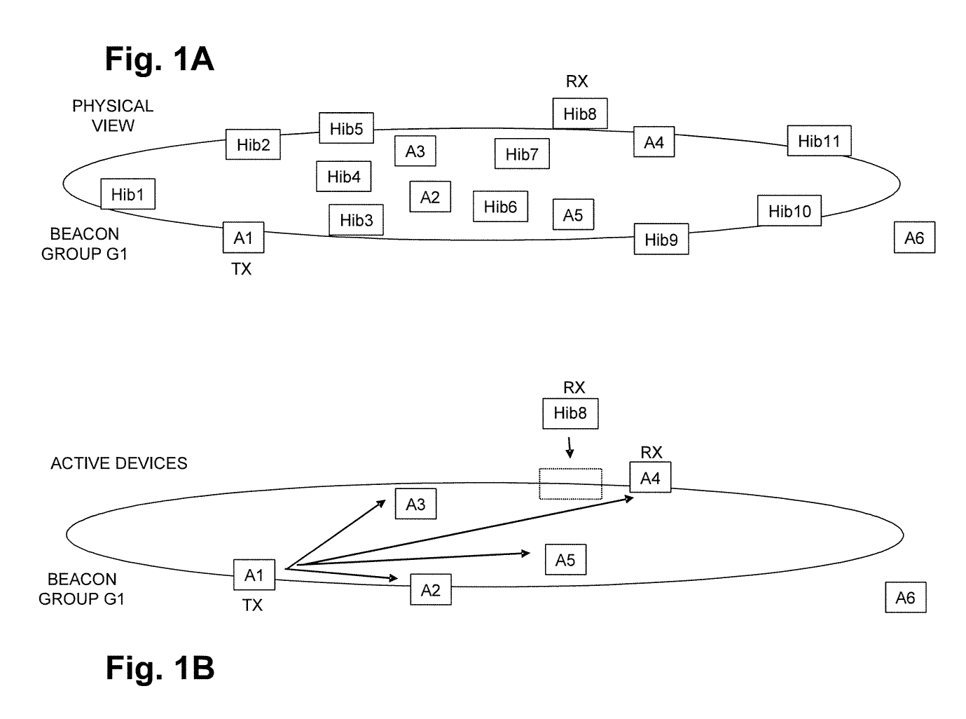

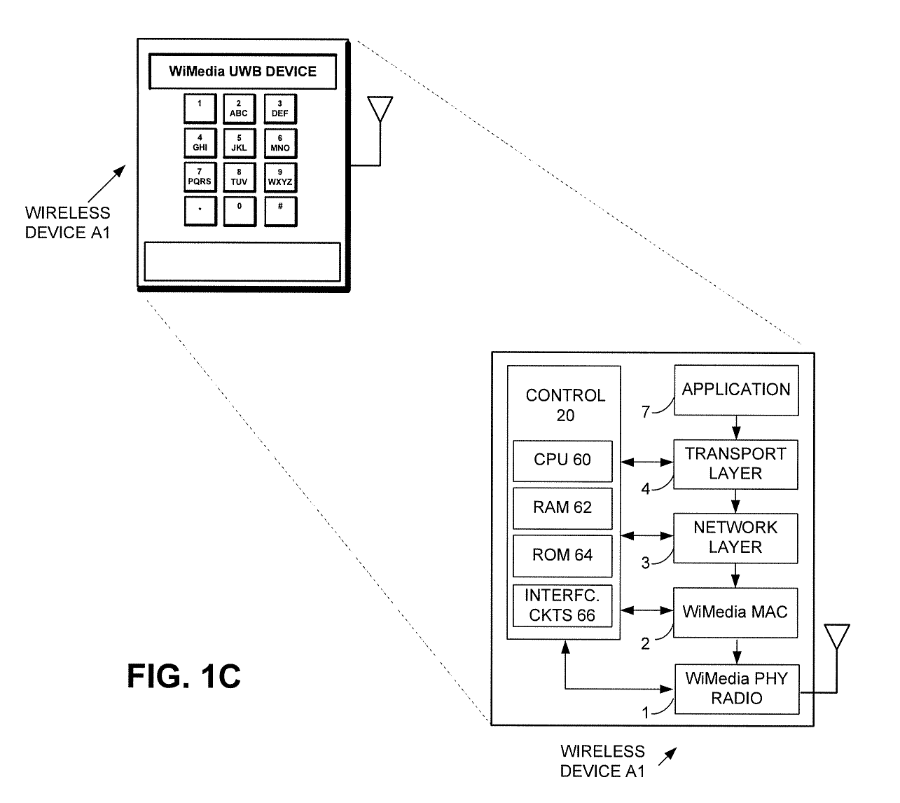

FIG. 1A is an example physical view of a short-range proximity network of wireless devices in a Beacon Group G1, incorporating the high rate physical layer (PHY) techniques the WiMedia Ultra-Wideband (UWB) Common Radio Platform. A Beacon Group is a set of wireless devices from which a device receives beacons that identify the same beacon period start time (BPST) as the receiving device. Beacon Group G1 includes devices A1, A2, A3, A4, A5 that are in the active mode and devices Hib1 to Hib11 that are in the in hibernation mode. Devices A1, A2, A3, A4, A5 in the active mode transmit and receive beacons in every superframe. Devices Hib1 to Hib11 in the hibernation mode hibernate for multiple superframes to save energy and do not transmit or receive during those superframes. To coordinate with neighboring devices, a device indicates its intention to hibernate by including a Hibernation Mode information element (IE) in its beacon. The Hibernation Mode IE specifies the number of superframes in which the device will hibernate and will not send or receive beacons or any other frames. Active Device A6 is also shown in FIG. 1A, which has recently drifted out of communications range from the other devices in Beacon Group G1.

The active device A1 in FIG. 1A wishes to send one or more packets during a particular sequence of superframes, to the hibernating device Hib8. Since the device Hib8 is not transmitting or receiving during those particular superframes, the active device A4 acts as temporary destination for those packets from device A1 to device Hib8, for later forwarding by device A4 to the device Hib8 when it returns to its active mode. One advantage of this embodiment of the invention is that hibernation times can be made longer to save energy, since data that needed to be sent to the hibernating device will be safely stored until the device wakes up. The hibernating time of device Hib8 could be relatively long and the motivation for initiating device A1 sending a forwarding request to a forwarder device for forwarding to device Hib8 may arise from, for example, an imminent buffer overflow in the device A1 or an imminent need for device A1, itself, to go into hibernation without waiting for device Hib8 to wake-up. The acknowledge messages are handled on link basis, but the success of the forwarding has to be reported from the final destination device to the initiating device. The initiating device understands that the speed of receiving the acknowledge from the destination device depends on the hibernation time of both initiating and destination devices. The speed (or the relative increase in delay compared with direct transmission) depends on the acknowledgement scheme.

FIG. 1B is an example view of only the active devices A1, A2, A3, A4, A5 in the Beacon Group G1 of FIG. 1A, the figure showing the transmission of the packets from device A1 to device A4 for later forwarding to device Hib8.

FIG. 1C illustrates an external view and a functional block diagram of an example embodiment of any of the wireless devices of FIG. 1A, such as device A1. The wireless device A1 can be a mobile communications device, PDA, cell phone, laptop or palmtop computer, or the like. The wireless device A1 includes a control module 20, which includes a central processing unit (CPU) 60, a random access memory (RAM) 62, a read only memory (ROM) 64, and interface circuits 66 to interface with the radio 1, battery and other energy sources, key pad, touch screen, display, microphone, speakers, ear pieces, camera or other imaging devices, etc. The RAM 62 and ROM 64 can be removable memory devices such as smart cards, SIMs, WIMs, semiconductor memories such as RAM, ROM, PROMS, flash memory devices, etc. The Transport Layer 4, Network Layer 3, and WiMedia MAC Layer 2, and/or application program 7 can be embodied as program logic stored in the RAM 62 and/or ROM 64 in the form of sequences of programmed instructions which, when executed in the CPU 60, carry out the functions of the disclosed embodiments. The program logic can be delivered to the writeable RAM, PROMS, flash memory devices, etc. 62 of the device A1 from a computer program product or article of manufacture in the form of computer-usable media such as resident memory devices, smart cards or other removable memory devices, or in the form of program logic transmitted over any transmitting medium which transmits such a program. Alternately, the Transport Layer 4, Network Layer 3, and WiMedia MAC Layer 2, and/or application program 7 can be embodied as integrated circuit logic in the form of programmed logic arrays or custom designed application specific integrated circuits (ASIC). The UWB radio 1 in device A1 operates at high data rates with low energy consumption in the 3.1 to 10.6 GHz UWB spectrum.

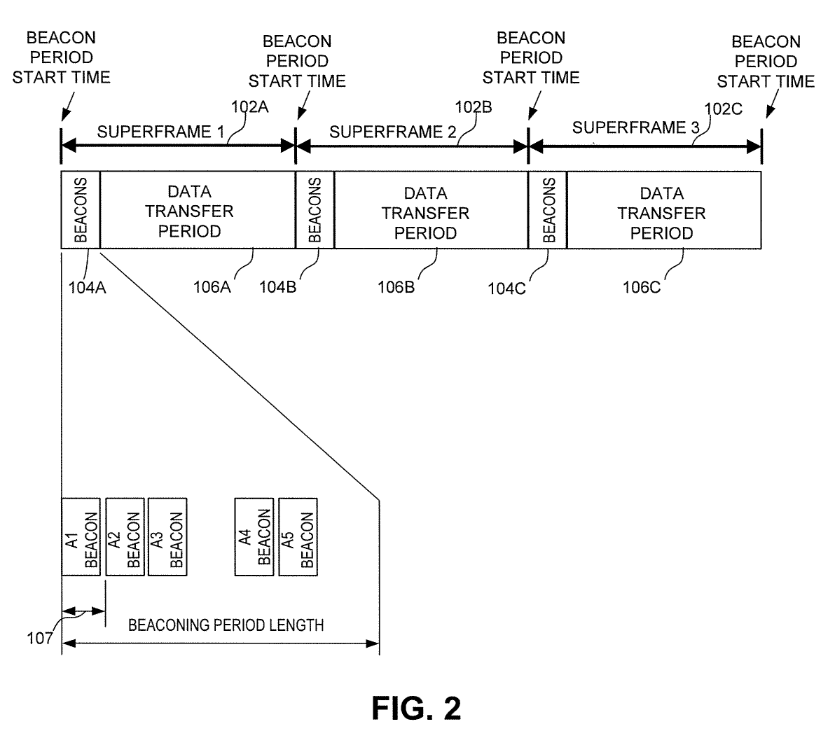

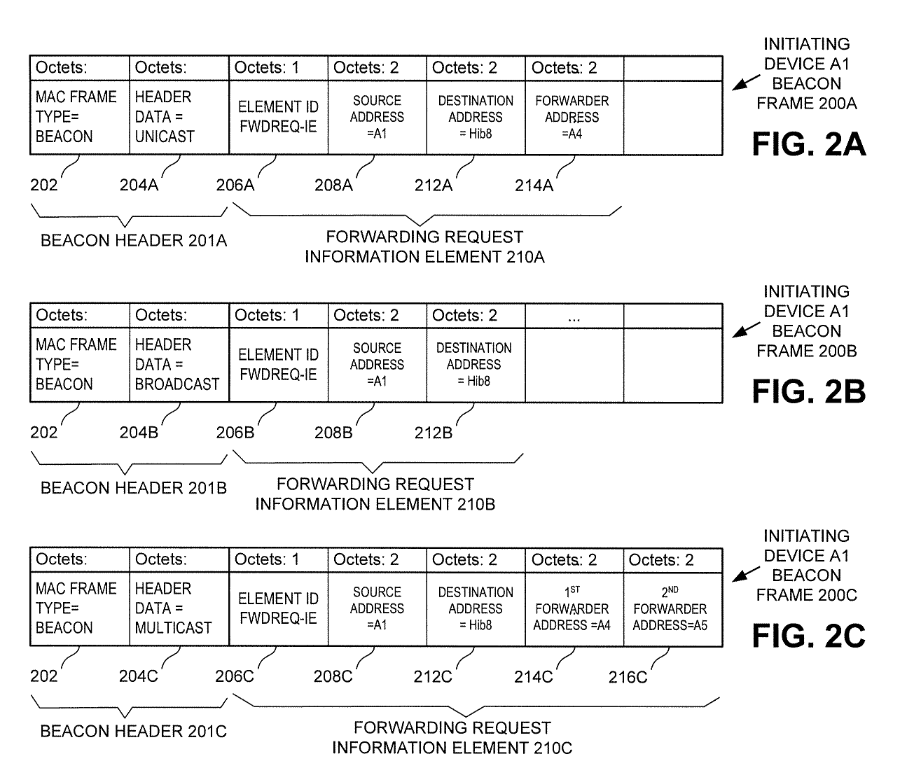

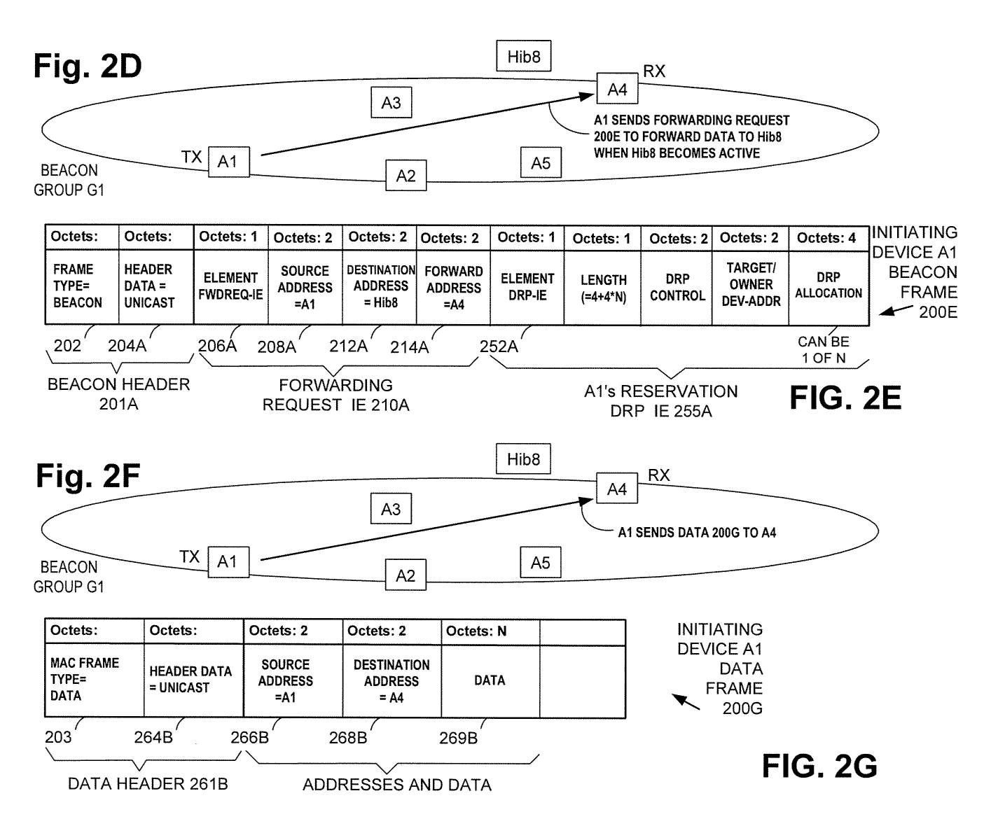

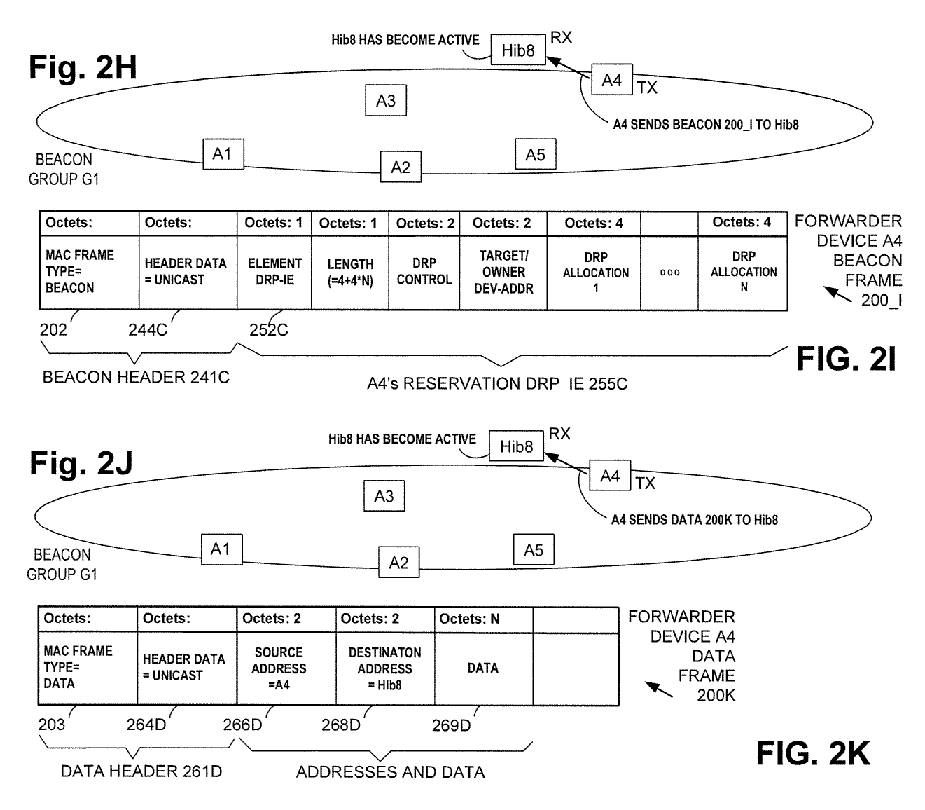

An example superframe format is shown in FIG. 2 with superframes 102A, 102B, and 102C. Each superframe 102 includes a beacon period (BP) 104 and a data transfer period (DTP) 106. The Medium Access Control (MAC) sub-layer of the Data Link layer 2 in each device governs the exchange of beacon frames. Beacon periods 104 convey beacon frames, which are transmitted from each of the active devices in the beaconing group. Accordingly, each beacon period 104 includes multiple beacon slots 107. Slots 107 each correspond to a particular device A1, A2, A3, A4, A5 in the network. The devices employing beacon slots 107 are referred to as a beaconing group. During these slots, the corresponding device may transmit various overhead or networking information, for example, to set resource allocations and to communicate management information for the beaconing group. For WiMedia networks, such information is transmitted in Information Elements (IEs).

The data transfer period 106 is used for devices to communicate data according to various transmission schemes, for example, frequency hopping techniques that employ OFDM and/or time frequency codes (TFCs). In addition, devices may use data transfer periods 106 to transmit control information, such as request messages to other devices, and the WiMedia MAC provides for command and control frames for the transfer of such information. To facilitate the transmission of traffic, each device may be allocated one or more scheduled time slots within each data transfer period 106, which are referred to as media access slots (MASs) in which two or more devices can exchange data. Media access slots (MASs) may be allocated among devices within the beacon group by the distributed reservation protocol (DRP), which protects the MASs from contention access by devices acknowledging the reservation. Alternatively, resource allocation can be provided according to a prioritized contention access (PCA) protocol, which is not constrained to reserving one or more entire MASs, but instead, can be used to allocate any part of the superframe that is not reserved for beaconing or DRP reservations. The WiMedia frame format has successive superframes 102, each of which includes 256 media access slots (MASs) and has a duration of 65,536 microseconds. Within each superframe 102, a first set of media access slots (MASs) is designated as the beaconing period 104, in which the number of MASs is flexible and may dynamically change. Various information elements (IEs) are transmitted in the beacon frame to transmit control information, including for example distributed reservation protocol (DRP) IEs, which are used to negotiate a reservation for certain media access slots (MASs) in the data transfer period 106 and to announce the reserved MASs. The remaining non-beaconing period portion of superframe 102 is the data transfer period 106.

The availability of propagation paths between the wireless devices of a beacon group changes frequently because some devices enter into or emerge from the hibernation mode. In addition, the availability of propagation paths between the wireless devices of a beacon group changes frequently because of the relative motion of the devices, causing some devices to move behind an obstruction, or in close proximity to an interfering radio source, or out of range. An initiating device that wishes to exchange packets with a destination device that is not currently available, must locate another active, forwarder device in the beacon group to which to forward the packets and must indicate to the forwarder device the identity of the intended destination device. There are several example embodiments of the invention to enable the initiating device to locate a suitable forwarder device and to indicate to the forwarder device the identity of the destination device.

One example embodiment of the invention is for the initiating device to indicate its need in its beacon transmitted to a forwarder device. For example, if its intended destination is hibernating or unreachable with the required quality or rate, as shown in FIG. 1B, the initiating device can send a Forwarding Request information element (IE) its beacon frame.

FIGS. 2A, 2B, and 2C illustrate examples of Forwarding Request information elements (IE) in the beacon frame of the initiating device A1. The Forwarding Request information element (IE) can be sent by an initiating device A1 by either unicasting to a single, specifically addressed wireless device, for example A4, or multicasting to several specifically addressed wireless devices, for example A3 and A4, or broadcasting to all wireless devices A2, A3, A4, A5 capable of receiving the beacon. In embodiments of the invention, the Forwarding Request information element specifies to another device, information related to forwarding data from the initiating device via a forwarder device to an intended destination device that is hibernating or otherwise unreachable. The beacon frame includes a beacon header that identifies the MAC frame as a beacon frame. The header shown in FIGS. 2A, 2B, and 2C is a MAC header with the frame type designated as a beacon frame and the addressing generally referred to as either unicast, multicast, or broadcast. This is an abbreviated representation of a beacon header and does not show other fields usually included, such as frame control fields, the source and destination addresses, sequence control fields, and access information. The payload portion of the beacon frame includes the Forwarding Request information element which contains an element ID and various parameters for the information element.

FIG. 2A illustrates an example of a Forwarding Request information element (IE) 210A in a beacon frame 200A that an initiating device A1 can send by unicast to a forwarder device A4, as shown in FIG. 1B, to request the forwarder device to receive, buffer, and forward data to an intended destination device Hib8 that is hibernating or unreachable. The beacon frame 200A includes the beacon header 201A with field 202 that identifies the MAC frame as a beacon frame and field 204A that identifies the transmission as unicast. The payload portion of the beacon frame includes the information element 210A which contains the element ID 206A designating the IE as a Forwarding Request IE (FWDREQ), the source address 208A of the initiating device A1, the destination address 212A of the destination, hibernating device Hib8, and the forwarder address 214A of the forwarder device A4. The hibernating time of device Hib8 could be relatively long and the motivation for initiating device A1 sending a forwarding request to a forwarder device for forwarding to device Hib8 may arise from, for example, an imminent buffer overflow in the device A1 or an imminent need for device A1, itself, to go into hibernation without waiting for device Hib8 to wake-up.

Each Active device knows the status of its nearest neighbors by the information in their respective beacons. Forwarder device A4 knows when the hibernating device Hib8 will wake up, by the Hibernation Mode information element (IE) in Hib8's last beacon, which specified the number of superframes in which the device will hibernate. Forwarder device A4 temporarily stores the data received from initiating device A1 and will forward it to the intended destination device Hib8 when Hib8 becomes active again. One advantage of this embodiment of the invention is that hibernation times can be made longer to save energy, since data that needed to be sent to the hibernating device will be safely stored until the device wakes up.

FIG. 2B is a broadcast transmission of Forwarding Request IE (FWDREQ) in a beacon frame 200B that an initiating device A1 can send to all devices A2, A3, A4, A5 that are capable of receiving the beacon. Other reference numbers with the suffix “B” refer to the similar fields as those with the suffix “A” in FIG. 2A. If two (or more) active devices A4 and A5 have the same hibernating neighbor, Hib8, then each candidate device A4 and A5 can compare a threshold value with the last measured signal strength each has respectively, most recently received from Hib8 when it was in the active mode, and only respond to device A1's request if the last measured signal strength was greater than the threshold value. In an alternate embodiment, each candidate forwarder device A4 and A5 can compare the remaining number of superframe cycles that the hibernating device Hib8 will hibernate, with the number of cycles remaining before the respective candidate device A4 or A5 is scheduled to enter the hibernation mode, and only respond to device A1's request if the respective candidate device A4 or A5 will be active when device Hib8 emerges from hibernation. In another alternate embodiment, devices A4 and A5 can respond to device A1's request, by each replying with the number of superframe cycles it has remaining before the respective candidate device A4 or A5 is scheduled to enter the hibernation mode, allowing the initiating device A1 to select which candidate device has the longer duration in the active mode overlapping with that of the device Hib8, after it emerges from hibernation, thus increasing the probability that there will be sufficient time for the selected candidate device A4 or A5 to forward all of the data that the initiating device requires to be forwarded. In another alternate embodiment, devices A4 and A5 can respond to device A1's request, by each replying with the residual battery energy it has remaining or the fact that the responding device is connected to the mains energy supply, allowing the initiating device A1 to select which candidate device has the greater residual energy source, thus increasing the probability that there will be sufficient energy for the selected candidate device A4 or A5 to forward all of the data that the initiating device requires to be forwarded.

In its decision on choosing which forwarder device from the responding candidate devices A4 and A5, the initiating device A1 can combine a first factor of the overlapped active time of device Hib8 with of each candidate device A4 and A5, combining it with a second factor of the last received signal strength from device Hib8 that was received by each respective candidate device A4 and A5. For example if one of the candidate devices A4 or A5 has a longer overlapped active time with device Hib8, that may be more important than that candidate device having a slightly lower received signal strength from Hib8. Alternately, the initiating device A1 can combine either the first factor or second factor or both factors with the residual battery energy the candidate device A4 or A5 has remaining or the fact that the candidate device is connected to the mains energy supply in its decision on choosing which forwarder device A4 or A5 to use. Those devices that are energized by the relatively constant mains, may be preferred as a forwarder node since the device would not deplete its residual energy as would a battery-energized device and would not likely postpone the information delivery by going into hibernation.

FIG. 2C is a multicast transmission of Forwarding Request IE (FWDREQ) in a beacon frame 200C, specifically addressing two or more potential forwarder devices, such as A4 in field 214C and A5 in field 216C. Other reference numbers with the suffix “C” refer to the similar fields as those with the suffix “A” in FIG. 2A. The initiating device A1 can choose which candidate forwarder devices it will address in its multicast beacon in FIG. 2C, by comparing data received from one or more of the candidate devices A2, A3, A4, A5. For example, a candidate forwarder device A4 can collect a last measured link quality index (LQI) for each active device and each hibernating device in its respective neighborhood. The candidate device A4 can also compile a list of the remaining number of superframes in the hibernation mode of each neighboring hibernating device to the respective candidate forwarder device A4. The candidate device A4 can also compile a list of the residual battery energy that each neighboring device has remaining or the fact that the neighboring device is connected to the mains energy supply. Each candidate forwarder device can transmit to the initiating device A1 the compiled data about the candidate device's respective nearest neighbors and also transmit the candidate device's own data on the number of cycles it has remaining until the candidate device starts its own hibernation mode and its own residual battery energy. The activity of the candidate forwarder device in collecting data about its neighboring devices can be an ongoing, spontaneous collecting activity, which it periodically broadcasts to other devices in the beacon group. Alternately the candidate device A4, for example, may perform its data collecting activity in response to a prior request for information from the initiating device A1. As a further alternative, a dedicated information collecting wireless device may collect data about its neighboring devices in an ongoing, spontaneous collecting activity, which it periodically broadcasts to other devices in the beacon group.

Upon receiving the multicast transmission of Forwarding Request IE (FWDREQ) of FIG. 2C, each of the devices A4 and A5 can respond in a manner similar to that described above for FIG. 2B, by replying with its LQI values or its hibernation cycle values that the initiating device A1 can evaluate. In an alternate embodiment of the invention, candidate devices A4 and A5 can communicate between themselves and compare the signal strength each has most recently received from Hib8 when it was in the active mode, and devices A4 and A5 can select between themselves which device, A4 or A5, received the greater signal strength and thus, will serve as the forwarder device for forwarding data from the initiating device A1 to device Hib8.

FIG. 2D shows an example view the active devices in the Beacon Group G1 of FIG. 1A, with initiating device A1 sending a beacon frame 200E to the forwarder device A4 to request A4 to forward data to the currently hibernating destination device Hib8 after Hib8 emerges from its hibernation mode.

FIG. 2E shows an example of the initiating device A1's beacon frame 200E in FIG. 2D, conveying the Forwarding Request information element (IE) 210A to the forwarder device A4 to request A4 to forward data identified in the Reservation DRP IE 255A to the currently hibernating destination device Hib8 after Hib8 emerges from its hibernation mode. Reservation DRP IE 255A includes fields 252A for the DRP-IE element, length (4+4*N for N number of DRP allocation fields), DRP control, target/owner DevAddr, and one or more DRP allocation fields. The Reservation DRP IE 255A may also be sent by device A1 to device A4 in another beacon.

FIG. 2F shows an example view the active devices in the Beacon Group G1 of FIG. 1A, with initiating device A1 sending a data frame 200G to the forwarder device A4.

FIG. 2G shows an example of the initiating device A1's data frame 200G in FIG. 2F, conveying the data to the forwarder device A4. The data frame 200G includes the data header 261B with field 203 that identifies the MAC frame as a data frame and field 264B that identifies the transmission as unicast. The payload portion of the data frame includes the source address of initiating device A1 in field 266B and the destination address for this transmission is the forwarder device A4 indicated in field 268B. The data is in the data field 269B.

FIG. 2H shows an example view the active devices in the Beacon Group G1 of FIG. 1A, with forwarder device A4 sending a beacon frame 200_I to the destination device Hib8 after Hib8 emerges from its hibernation mode.

FIG. 2I shows an example of the forwarder device A4's beacon frame 200_I in FIG. 2H, conveying the Reservation DRP IE 255C for the data, to the destination device Hib8 after Hib8 emerges from its hibernation mode. Reservation DRP IE 255C includes fields 252C for the DRP-IE element, length (4+4*N for N number of DRP allocation fields ), DRP control, target/owner DevAddr, and one or more DRP allocation fields, identifying that the reservation is for a data transmission from device A4 to device Hib8 and specifying the time slot for the data frame in the data transfer period. The Reservation DRP IE 255C may also be sent by device A4 to device Hib8 in another beacon.

FIG. 2J shows an example view the active devices in the Beacon Group G1 of FIG. 1A, with forwarder device A4 sending a data frame 200K to the destination device Hib8 after Hib8 emerges from its hibernation mode.

FIG. 2K shows an example of the forwarder device A4's data frame 200K in FIG. 2J, conveying the data to the destination device Hib8 after Hib8 emerges from its hibernation mode. The data frame 200K includes the data header 261D with field 203 that identifies the MAC frame as a data frame and field 264D that identifies the transmission as unicast. The payload portion of the data frame includes the source address of forwarding device A4 in field 266D and the destination address for this transmission is the destination device Hib8 indicated in field 268D. The data is in the data field 269D.

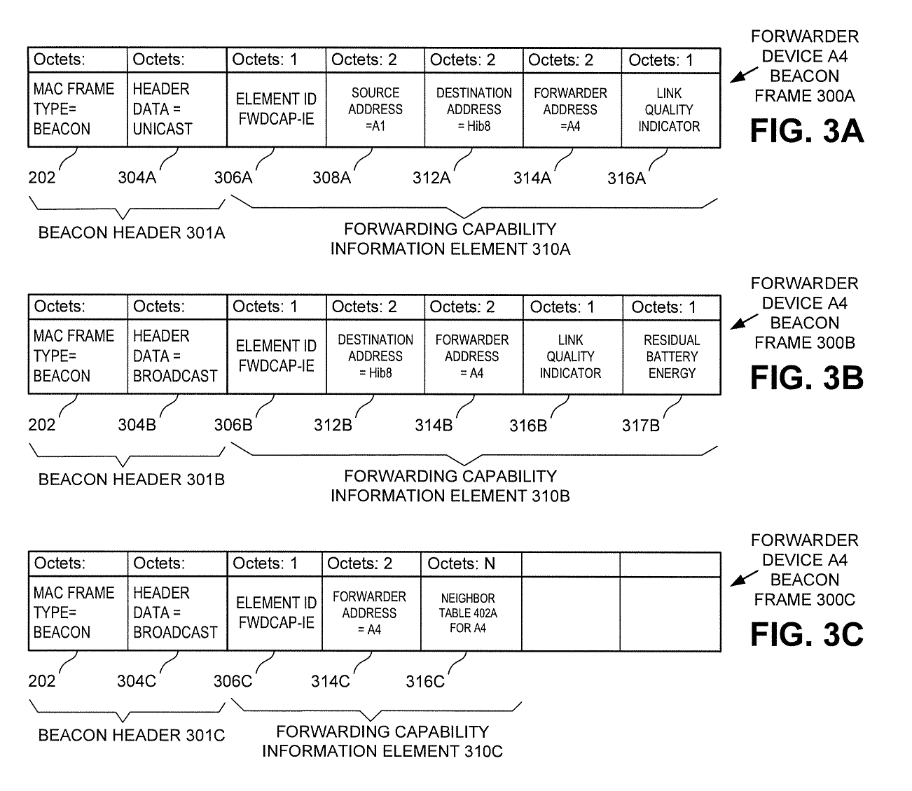

In another example embodiment of the invention, instead of the Forwarding Request IE indicating an urgent need by the initiating device A1 to immediately forward its data, the Forwarding Request IE of FIGS. 2A, 2B, and 2C can serve as an announcement of the intention of the initiating device A1 to send one or more packets or frames to Hib8. Active devices, such as device A4, can respond with a Forwarding Capability IE (FWDCAP-IE) 310A in its beacon, as shown in FIG. 3A, to announce its capability to forward those packets or frames to the hibernating device Hib8. Additional information can be included in the Forwarding Capability IE sent by device A4, such as a link quality indicator (LQI) 316A to enable the initiating device A1 to select which responding device, A2, A3, A4, or A5 would be the best forwarder device, if several devices have responded. The link quality indicator (LQI) can indicate, for example, the signal strength each responding device A2, A3, A4, or A5 has most recently received from Hib8 when Hib8 was in the active mode. Additional information can be included in the Forwarding Capability IE sent by device A4, such as the residual battery energy 317B it has remaining or the fact that the responding device is connected to the mains energy supply, allowing the initiating device A1 to select which candidate device has the greater residual energy source, thus increasing the probability that there will be sufficient energy for the selected candidate device A4 to forward all of the data that the initiating device requires to be forwarded.

The beacon 300A of FIG. 3A is transmitted by the forwarder device A4 during the dedicated beacon period 104 allocated for beacon transmissions in the superframe 102, to the initiating device A1, for maintaining coordination with one or more other wireless devices, such as destination device Hib8, within the beacon group G1 network. The beacon 300A includes an indication, the forwarding Capability IE 310A, of the forwarder device A4's capability to forward information to the destination device within the network.

In another example embodiment of the invention, to reduce the number of devices that need to reply, the initiating device A1 may send a multicast Forwarding Request IE (FWDREQ) to a subset of devices, as shown in FIG. 2C. The selection by initiating device A1 of which candidate forwarder devices A4 and A5 to include in the multicast request, can take into account, for example, known hibernation cycles of those devices. The Forwarding Request IE (FWDREQ) in this case includes a sequence of addresses of devices A4 and A5 and only the addressed, candidate devices may respond. The responding devices, such as device A4, can respond with a Forwarding Capability IE (FWDCAP-IE) 310A in its beacon frame 300A, as shown in FIG. 3A. The optional link quality indicator (LQI) field may also properly set by A4 in field 316A to indicate, for example, the signal strength that A4 has most recently received from Hib8 when Hib8 was in the active mode. A candidate device can respond by replying with the residual battery energy 317B it has remaining or the fact that the responding device is connected to the mains energy supply.

In another example embodiment of the invention, when an active device prepares to go into hibernation and broadcasts its intention to hibernate by including a Hibernation Mode information element (IE) in its beacon, neighbor active devices can respond by broadcasting an advertisement of their capability to act as a forwarder for the device entering hibernation. This capability is proactively announced with a specific Forwarding Capability IE (FWDCAP-IE) 310B shown in its beacon frame 300B in FIG. 3B. For example, when the device Hib8 transitions from the active mode to the hibernation mode, its active neighbor device A4 broadcasts a Forwarding Capability IE (FWDCAP-IE) 310B shown in beacon frame 300B of FIG. 3B, which sets the forwarder address 314B equal to its own address (FwdAddr=A4) and sets the destination address 312B as the newly hibernating device (DestAddr=Hib8). The optional link quality indicator (LQI) field 316B may also properly set by A4 to indicate, for example, the signal strength that A4 has most recently received from Hib8 when Hib8 was in the active mode. A candidate device can respond in field 317B by replying with the residual battery energy it has remaining or the fact that the responding device is connected to the mains energy supply that provides a constant and reliable source of energy. Each device in the beacon group that receives the Forwarding Capability IE (FWDCAP-IE) 310B shown in FIG. 3B, such as device A1, stores the information for future use, in the event that it needs to send data to the device Hib8 while it in the hibernation mode. At that time, the initiating device, such as device A1, can send its data directly to the device A4 in this example, using the Forwarding Request IE (FWDREQ) 210A with the source address field (SrcAddr=A1) 208A, the forwarded address field (FwdAddr=A4) 214A, and the destination address field (DestAddr=Hib8) 212A, as in beacon frame 200A of FIG. 2A. Alternately, the capability of a forwarder device can be announced earlier, since the knowledge of the presence of a destination device that is scheduled to hibernate soon has been announced in its beacon to the other devices who will be making decisions about its hibernation length.

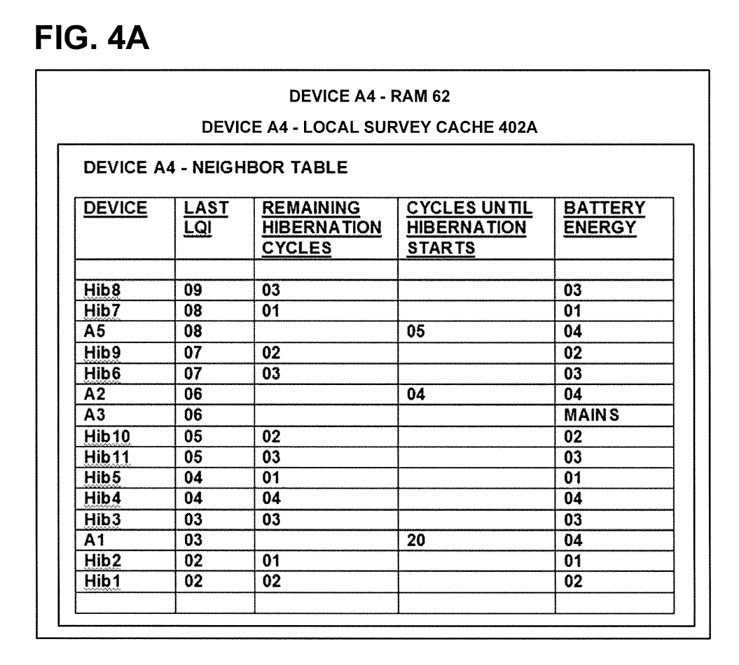

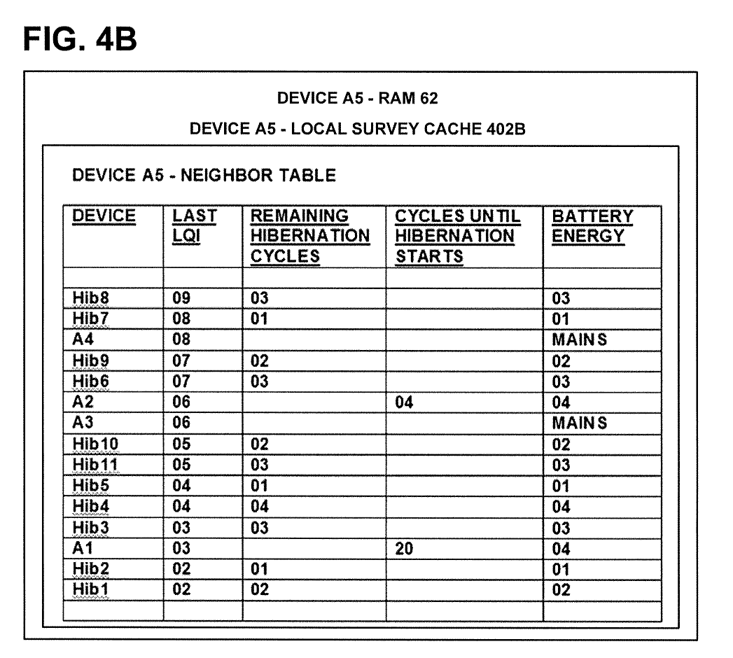

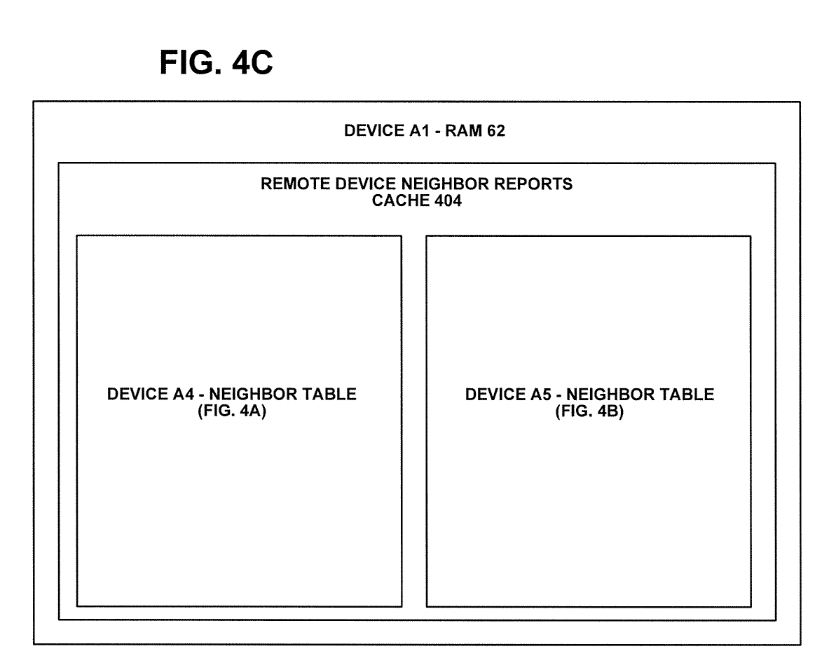

FIG. 3C shows an example of a beacon frame 300C from the forwarder device A4 with a Forwarding Capability information element (IE) (FWDCAP-IE) 310C spontaneously broadcast to all devices providing the neighbor table 402A of device A4 in field 316C, as shown in FIG. 4A, for all neighboring devices to device A4.

FIG. 4A shows an example of a neighbor table for device A4 in local survey cache 402A in the memory 62 of device A4. The table collects the last measured link quality index (LQI) for each active device and each hibernating device in the neighborhood of device A4. The table also lists the remaining number of superframes in the hibernation mode of each neighboring hibernating device to the device A4. The table also lists cycles until the hibernation mode starts of each neighboring active device to the device A4. The table also lists the residual battery energy for each neighboring device and lists those devices that are connected to the mains energy. Those devices, such as device A3 and A4, which are energized by the relatively constant mains, may be preferred as a forwarder node since the device would not deplete its residual energy as would a battery-energized device and would not likely postpone the information delivery by going into hibernation.

The forwarding capable device A4 can automatically pick information of the neighboring devices and advertise their presence, as for example in the neighbor table of FIG. 4A. The forwarding capable device A4 may alternate the information related to different neighbors in its beacon in subsequent beacon periods, as for example in the neighbor table of FIG. 4A. The forwarding capable device A4 may send additional beacon message(s) during the beacon period. The forwarding capable device A4 may use a different address in different beacon messages to identify itself. The forwarding capable device A4 may indicate in its beacon that this beacon does not contain all the neighbor-related information, but more can be found from the next beacons. The forwarding capable device A4 may send additional information of the neighbors on request, as for example in the neighbor table of FIG. 4A. The forwarding capable device A4 may indicate in its beacon, the addresses of other devices for which it has information that it can send on request, as for example in the neighbor table of FIG. 4A.

FIG. 4B shows an example of a neighbor table for device A5 in local survey cache 402B in the memory 62 of device A5, similar to that shown in FIG. 4A. The table collects the measured last link quality index (LQI) for each active device and hibernating device in the neighborhood of device A5. The table also lists the remaining number of superframes in the hibernation mode of each neighboring hibernating device to the device A5. The table also lists the remaining number of cycles until the hibernation mode starts of each neighboring active device to the device A5. The table also lists the residual battery energy for each neighboring device and lists those devices that are connected to the mains energy. Those devices, such as devices A3 and A4, which are energized by the relatively constant mains, may be preferred as a forwarder node since the device would not deplete its residual energy as would a battery-energized device and would not likely postpone the information delivery by going into hibernation.

FIG. 4C shows an example of a remote-device neighbor-reports cache 404 in the memory 62 of device A1, which has received and stored copies of the neighbor table in FIG. 4A from device A4 and the neighbor table in FIG. 4B from device A5. The selection by initiating device A1 of which candidate forwarder device to address in a Forwarding Request information element (IE), can take into account, for example, known hibernation cycles of those devices represented in the stored copies of the neighbor tables and/or the residual energy supply for the candidate device.

The initiating device A1 can select more than one forwarder device A4 and A5, and can allocate a portion of the forwarded data to each device A4 and A5, to for load balancing. The respective values of the link quality index (LQI) field and/or the residual energy supply can be used in allocating a portion of the data to each device A4 and A5. For example, better links may be favored over poor links, or poor links can be avoided completely. Alternately, delay sensitive or other higher priority traffic can be forwarded to the device A4 or A5 having the better links and the remaining part through the other device. The forwarder device may prioritize traffic from different sources by using priority information included in the traffic or channel reservation.

The link quality index (LQI) value may have meaning other than for pure link quality. For example, the value given to the optional LQI field can be simply an indicator of the extent to which the forwarder device A4 or A5 is able or willing to forward the data, based on buffering limitations or other local parameters.

The reception of the transmission from a source device to a destination device may fail due to different causes, which manifest in different ways:

a) The destination does not receive the frames sent by the source. The receiver does not receive any signal. For example, the MAC sub-layer sees that no signal was detected from the PHY. In WiMedia networks, in case the destination is receiving during the time dedicated to beacon frame transmission, the destination marks the corresponding beacon slot as unoccupied.

b) The frames sent by the source get corrupted at the destination. This is indicated by an invalid header check sequence (HCS). In WiMedia networks, in case a beacon frame was sent (i.e., the destination is receiving during the time dedicated to beacon frame transmission), the destination marks the corresponding beacon slot as occupied and the address is set as the broadcast address BcstAddr to indicate a collision.

c) The destination captures a stronger simultaneous transmission. This is indicated by a valid HCS, but the source of this frame is not the one that was expected to be. In WiMedia networks, in case a beacon frame was sent, the destination marks the corresponding beacon slot as occupied and the address is set as the device address DevAddr of the stronger device.

Such conditions of a bad link between an intended source and a destination may be present in both directions or in one direction only, leading in the latter case to an asymmetric link.

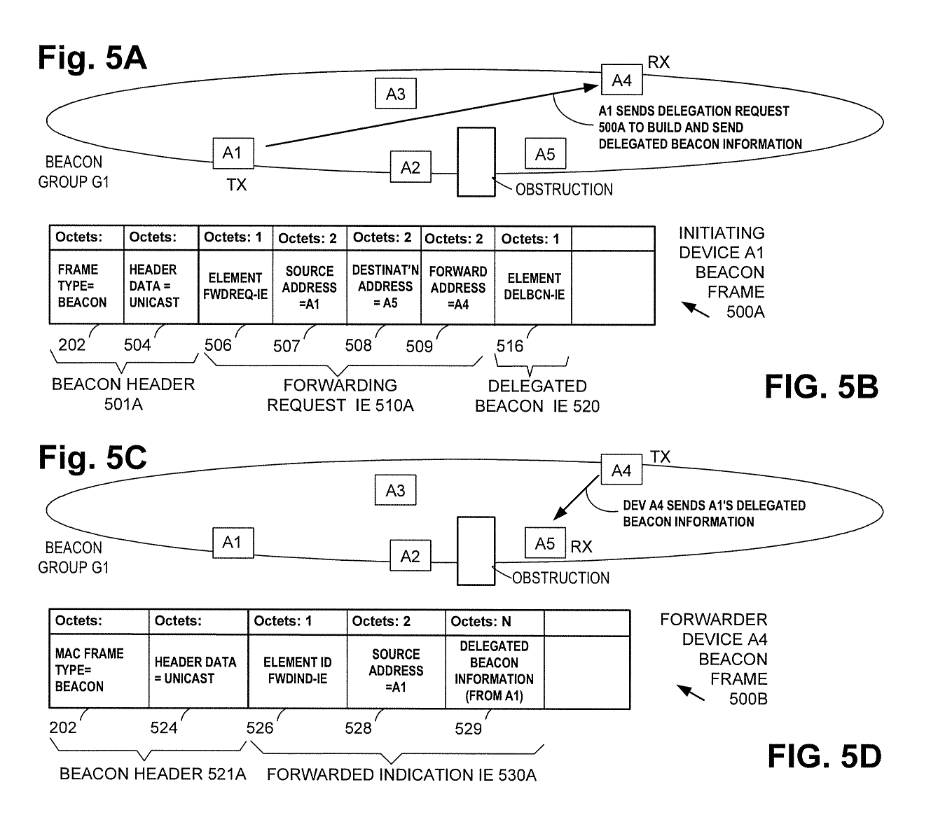

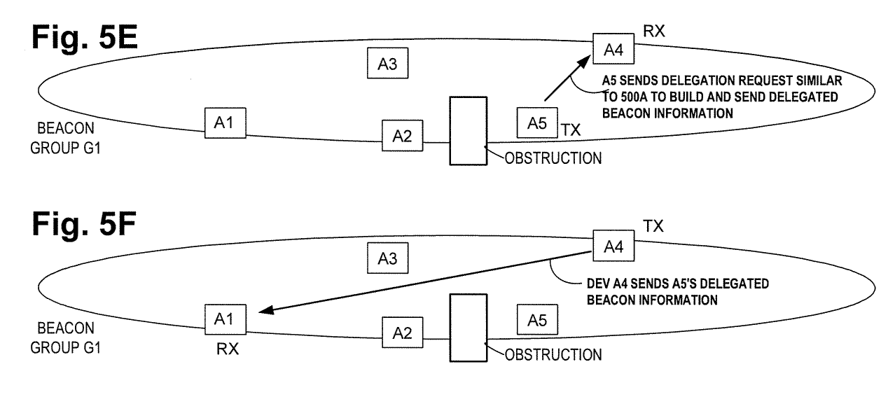

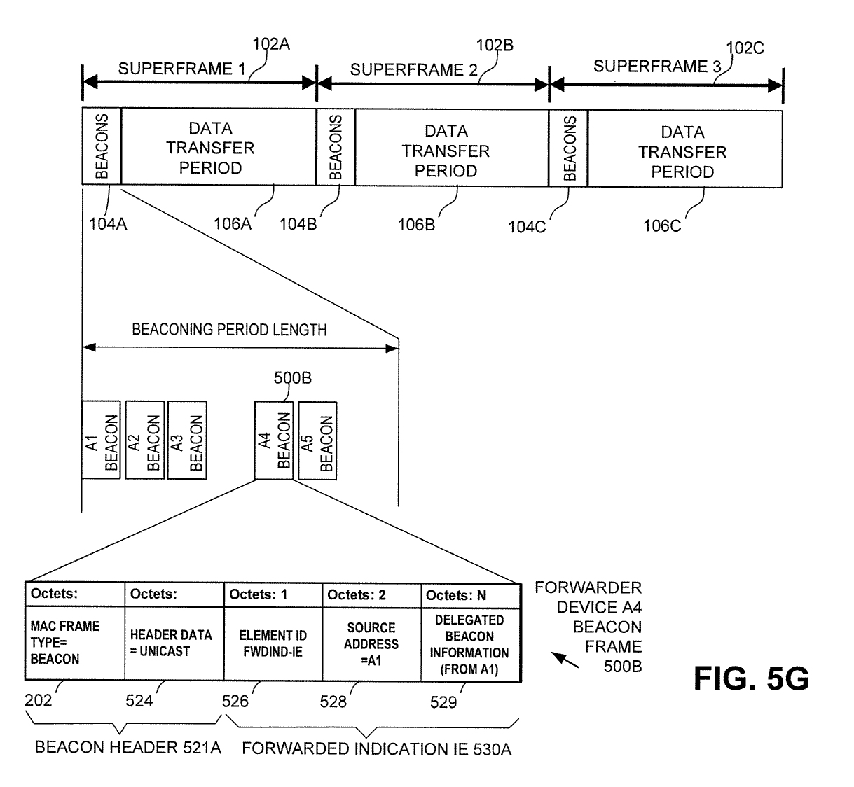

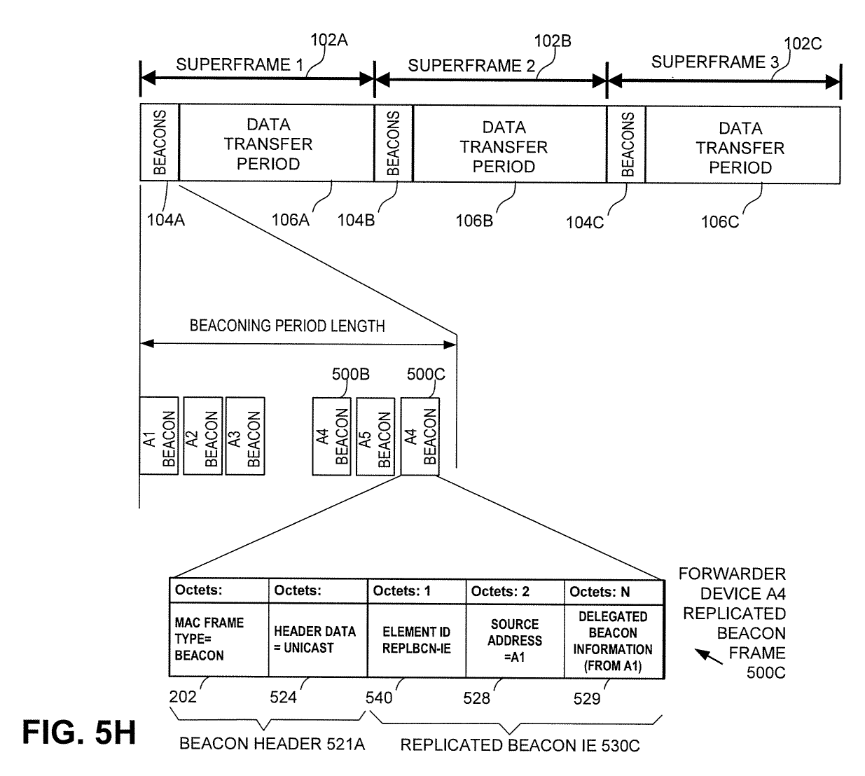

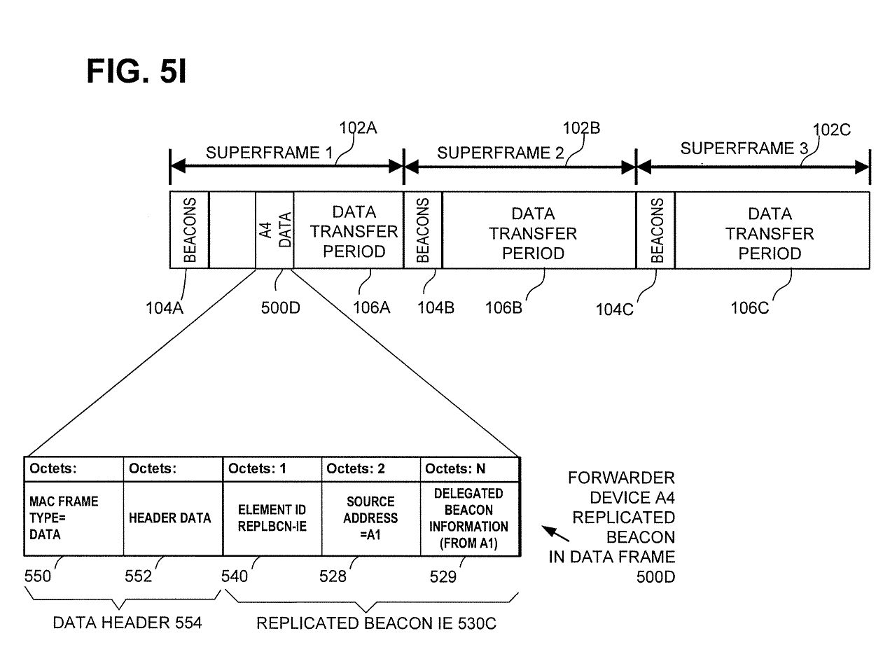

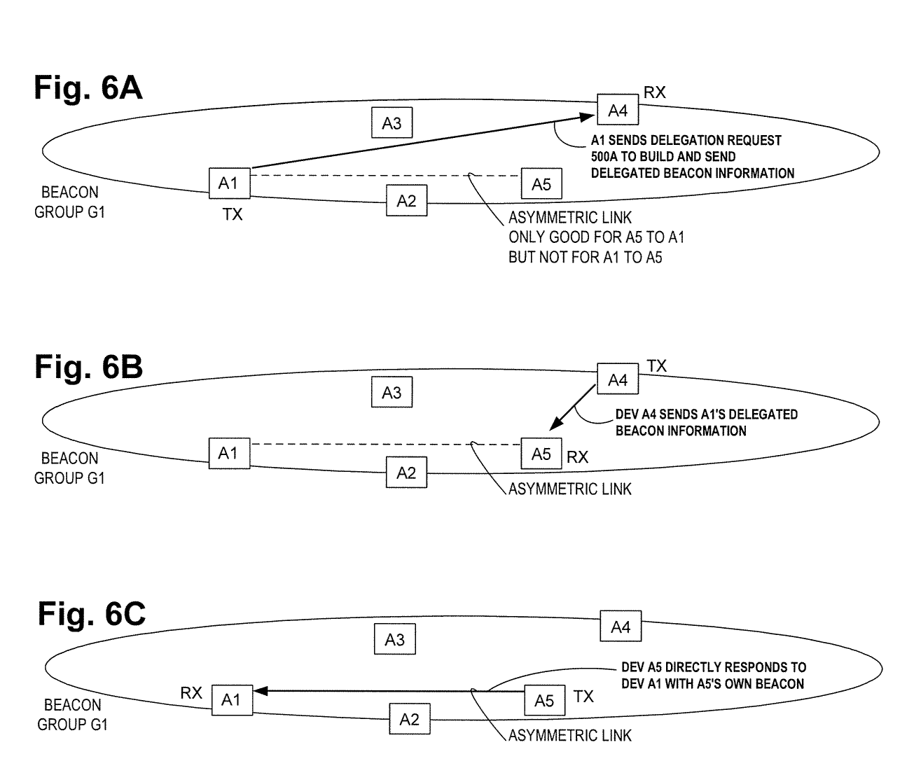

In case of an asymmetric link, as shown in FIG. 6A, a delegated beacon forwarded to a forwarder device provides the information in the missing beacon. In case of broken link, as shown in FIG. 5A, a delegated beacon forwarded to a forwarder device provides the information in the missing beacon sent both ways between the initiating and destination devices In both the case of broken links and in asymmetric links, the delegated beacon forwarding and/or data forwarding will be performed.

An example in which beacon forwarding without data forwarding occurs is where there is no link from the initiating device A1 to the destination device A5. The initiating device A1 wants its beacon received by device A5, but it does not need to send any data to device A5. Having all beacons available at all devices will help, for instance, in the reservation and use of the data transfer period, to avoid collisions. An example in which data forwarding without beacon forwarding occurs is where all devices, initiating device A1, forwarder device A4, and destination device A5, are in mutual coverage in the wireless network. Initiating device A1 wants to send data to destination device A5, which is currently hibernating. Forwarder A4 will store initiating device A1's data and deliver them at the first occasion to destination device A5 when it emerges from hibernation, but forwarder device A4 does not need to send any delegated beacon information.

FIG. 5A shows an example view the active devices in the Beacon Group G1 of FIG. 1A, with initiating device A1 sending a delegated beacon request in beacon 500A to forwarder device A4, requesting that a delegated beacon to be built by the forwarder device A4 based on the original beacon it previously received from the initiating device A1, to send to destination device A5, because of an obstruction blocking direct communication in either direction between initiating device A1 and destination device A5. FIG. 5B shows an example of a beacon 500A from initiating device A1 to forwarder device A4 in FIG. 5A, to enable device A1 to send a delegated beacon request to device A4 for building the delegated beacon to send to destination device A5. The beacon frame 500A includes the beacon header 501A with field 202 that identifies the MAC frame as a beacon frame and field 504 that identifies the transmission as unicast. The payload portion of the beacon frame includes the Forwarding Request IE (FWDREQ) 510A, which contains the element ID 506A designating the IE as a Forwarding Request IE (FWDREQ), the source address 507 of the initiating device A1, the destination address 508 of the destination device A5, and the forwarder address 509 of the forwarder device A4. The Delegated Beacon IE (DELBCN) 520 in field 516 tells the forwarder device A4 that the initiating device A1 is requesting that delegated beacon information is to be built by the forwarder device A4 based on the original beacon it previously received from the initiating device A1, to send to destination device A5.

FIG. 5C shows an example view the active devices in the Beacon Group G1 of FIG. 5A, with forwarder device A4 sending to destination device A5, the delegated beacon information it has built based on the original beacon it previously received from the initiating device A1, because of the obstruction blocking direct communication both ways between device A1 and device A5. FIG. 5D shows an example of a beacon 500B from forwarder device A4 to destination device A5 in FIG. 5C, to enable device A4 to forward the delegated beacon information to device A5. The beacon frame 500B includes the beacon header 521A with field 202 that identifies the MAC frame as a beacon frame and field 524 that identifies the transmission as unicast. The payload portion of the beacon frame includes the Forwarded Indication IE (FWDIND) 530A, which contains the element ID 526 designating the IE as a Forwarded Indication IE (FWDIND), the source address 528 of the initiating device A1, and the delegated beacon information in field 529.

The initiating device A1 in FIG. 1A can send a request to device A4, as in FIGS. 5A and 5B, to forward delegated beacon information of device A1 to device A5, as in FIGS. 5C and 5D, where an obstruction prevents transmissions in either direction between device A1 and device A5. Field 526 of FIG. 5D includes the forwarding indication FWDIND-IE, which indicates to the destination device A5 that the following field 529 contains delegated beacon information. The delegated beacon information in field 529 is built by the forwarder device A4 based on the original beacon it previously received from the initiating device A1, The format of the delegated beacon information depends on the specific forwarding method used by the forwarder device A4.

Where the obstruction also prevents transmissions from device A5 to be received by device A1, device A5 can mirror the steps in its reply by sending a beacon with a request to device A4 to forward a delegated beacon by device A5 to device A1, as in FIGS. 5E and 5F. FIG. 5E shows an example view the active devices in the Beacon Group G1 of FIG. 1A, with device A5 optionally responding by sending a delegated beacon request to forwarder device A4, requesting that a delegated beacon to be built by the forwarder device A4 based on an original beacon it previously received from the device A5, to send to device A1, because of the obstruction blocking direct communication in either direction between device A1 and device A5. FIG. 5F shows an example view the active devices in the Beacon Group G1 of FIG. 5E, with forwarder device A4 sending to device A1, the delegated beacon information it has built based on the original beacon it previously received from the device A5, because of the obstruction blocking direct communication both ways between device A1 and device A5.

The delegated beacon information in the Forwarded Indication IE 529 of FIG. 5D sent from the forwarder device A4 to the destination device A5, is for example, the information portion of the beacon that device A1 would have sent directly to device A5, if there had been no obstruction of the transmission path.

The beacon information normally sent by a member device in the beacon group, such as device A5, is correctly received by at least one other device in the group, such as device A4. Those devices, such as device A4, which correctly receive the beacon from the member device A5, may indicate to their neighbors, such as device A1, that device A4 will act as a forwarder device for the member device A5. Later, when an initiating device, such as device A1, detects that a beacon it has transmitted has not been correctly received or has been completely missed by an intended destination device, such as device A5, the initiating device A1 may request another device in the group, which is connected in both directions with it, such as device A4, to act as a forwarder device. This is done by issuing a Delegate Beacon Request IE, as shown in FIG. 5B. The request may be sent to all neighbors in the group by setting the forwarding address FwdAddr as the broadcast address BctAddr.

Upon reception of the request, the candidate delegated device A4 can indicate its availability by adding to its beacon a Delegate Beacon Accept IE, in which it can indicate its ability to communicate with the intended destination device A5. The candidate delegated device A4, at the same time or shortly thereafter, may start a procedure to reserve the necessary channel time for forwarding the delegated information to device A5. The delegated beacon information can be sent, without any additional reservation, for example, in the same beacon slot (BS) already assigned to it, if there is sufficient remaining time in that beacon slot. Otherwise the candidate delegated device A4 may reserve either an additional beacon slot or a portion of the data transfer period (DTP). The acquisition of possible additional reservations that may be needed, may be postponed until after the resolution of the delegation process is completed. A candidate delegated device A4 may alternately decide to proactively issue a Delegate Beacon Accept IE upon detection of the corresponding need of device A1.

The accepting delegated device A4 possesses the delegated beacon information by having received the original beacon sent by device A1, which failed to be received by the destination device A5. The accepting delegated device A4 then proceeds to build the delegated beacon information based on the original beacon, but the delegated beacon information may not include all of the original beacon fields. The size of the delegated beacon information is governed by the required or recommended information content needed for a properly functioning beacon that must accomplish its intended control or informational purpose at the destination device A5. Because of limitations on the maximum allowed duration for a beacon, the beacon slot size, and the maximum transmission speed, if the required or recommended information content for a delegated beacon cannot be fit into the remaining channel time in forwarder device A4's own beacon slot, then a different forwarding method should be chosen. For example the delegated beacon information can be forwarded by device A4 in a new, dedicated beacon slot or the delegated beacon information can be forwarded by device A4 in the data transfer period (DTP). However, reducing the delegated beacon information size by not including some of the required/recommended information should be taken only as a last choice. The delegated beacon that is forwarded by the accepting delegated device A4 is formatted in different ways depending on the chosen transmission method.

As a first way, the delegated beacon information is forwarded by device A4 within the same beacon slot, embedded in a Forwarded Indication IE. The delegated beacon information can be forwarded by fitting it in device A4's own beacon 500B, as shown in FIG. 5D and FIG. 5G. The delegating device A4 may remove redundant information from the delegated beacon information before sending it to device A5.

As a second way, the delegated beacon information is forwarded by device A4 in a new, dedicated beacon slot 500C, as shown in FIG. 5H, and the delegated beacon information can, for example, be a substantially replicated copy of the original beacon as if it were being sent by the initiating device A1. To denote that this is replicated information, at least for some of the devices that previously received the original beacon from device A1, this replicated beacon can be sent in several ways:
i) The replicated beacon can be sent as a new frame type designating it as a replica; or alternatively,
ii) The replicated beacon can be sent as a regular beacon frame, of a newly specified frame subtype designating it as a replica; or alternatively,
iii) The replicated beacon can be sent as a regular beacon frame of default type, in which it is inserted as the first information element (IE), a Replicated Beacon IE, designating it as a replica.

As a third way, the delegated beacon information is forwarded by device A4 in a data frame 500D in the data transfer period (DTP), as shown in FIG. 5I, where the Replicated Beacon IE is embedded in the payload of a regular data frame. In this case, the location of the information is indicated by device A4 in a Delegated Beacon Pointer IE of a beacon sent in its beacon slot. The corresponding regular distributed reservation protocol DRP IE is also issued by the delegated device A4.

In order to achieve a load balancing for the forwarding process, the initiating device A1 may distribute its Forwarding Request IE to several devices A3 and A4 in the beacon group, which are connected in both directions with devices A1 and A5, to act as forwarder devices. The proportion of the forwarded traffic that the initiating device A1 allocates to each accepting forwarder device A3 and A4 can be based, for example, on the link quality (LQI), buffer size, overlapped active time, residual battery energy, or other factor that each respective forwarder device A3 and A4 reports in its Forwarding Capability IE as its capability to forward information to the destination device A5.

FIG. 6A shows an example view the active devices in the Beacon Group G1 of FIG. 1A, with device A1 sending a delegated beacon request to device A4 for forwarding beacon information to device A5, because of an asymmetric link, which is only good for transmissions from device A5 to device A1, but is not good for transmissions from device A1 to device A5. An asymmetric link occurs when device A1 is able to correctly receive from device A5, but device A5 cannot correctly receive from device A1. This phenomenon may be caused by propagation conditions, but can also be caused by exposure of device A5 to interference. A delegated beacon is based on the beacon information received from the initiating device, but whose format depends on the specific forwarding method used by the forwarder device. FIG. 6B shows an example view the active devices in the Beacon Group G1 of FIG. 6A, with device A4 forwarding the delegated beacon information of device A1 to device A5, because of the asymmetric link blocking direct transmissions from device A1 to device A5. If device A5 needs to send its beacon to device A1, FIG. 6C shows device A5 directly transmitting its response to device A1 with A5's own beacon, since the link is only good for transmissions in the direction from device A5 to device A1.

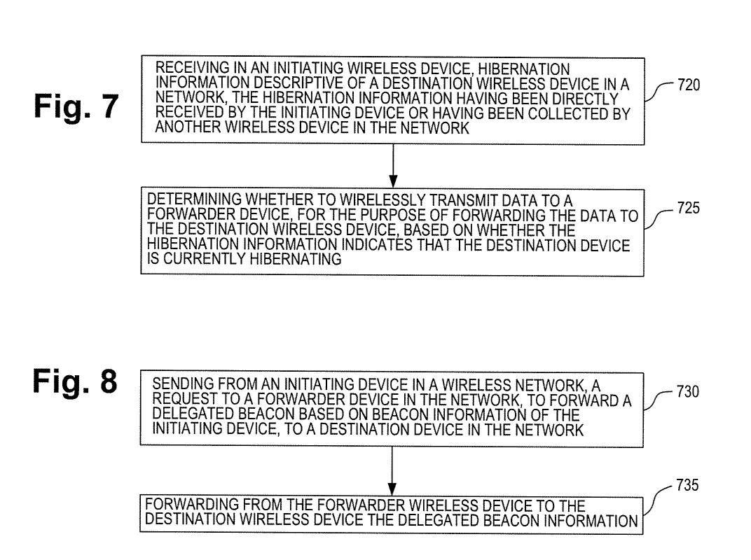

FIG. 7 is an example flow diagram of an example embodiment, for receiving in an initiating wireless device, hibernation information descriptive of a target/final destination wireless device in a network. The hibernation information can have been directly received by the initiating device or it may having been collected from other information collecting devices in the network. The method continues by the initiating device determining whether to wirelessly transmit data to a potential forwarder device, for the purpose of forwarding the data to a target/final destination wireless device, based on whether the hibernation information indicates that the target/final destination device is currently hibernating. The flow diagram can be embodied as program logic stored in the RAM 62 and/or ROM 64 in the form of sequences of programmed instructions which, when executed in the CPU 60, carry out the functions of the disclosed embodiments.

In an example embodiment, the method can include step 720 of receiving in an initiating wireless device A1, hibernation information descriptive of a destination wireless device Hib8 in a network, the hibernation information having been directly received by the initiating device A1 or having been collected by another wireless device A4 in the network. Then step 725 continues by determining whether to wirelessly transmit data to a forwarder device A4, for the purpose of forwarding the data to the destination wireless device Hib8, based on whether the hibernation information indicates that the destination device Hib8 is currently hibernating.

The initiating device A1 in FIG. 1A can have received the hibernation schedule information from the hibernating device Hib8 at a previous time when Hib8 was in the active mode and broadcasting its hibernation schedule. Alternately, initiating device A1 can have received the hibernation information from the forwarder device A4, by means of device A1 requesting the information from device A4 as in FIG. 2A. Alternately, the device A4 may have advertised the hibernation information by broadcasting it as in FIG. 3B or FIG. 3C and device A1 received it in that manner. The steps of the method represented by the flow diagram of FIG. 7 can, for example, be performed under control of the medium access control (MAC) layer 2. The medium access control (MAC) layer 2, for example, can be a sub-layer of a Data Link layer of the WiMedia Ultra-Wideband (UWB) Common Radio Platform.

FIG. 8 is an example flow diagram of an example embodiment, for sending a request to forward a beacon information by a first device to another wireless device. The flow diagram can be embodied as program logic stored in the RAM 62 and/or ROM 64 in the form of sequences of programmed instructions which, when executed in the CPU 60, carry out the functions of the disclosed embodiments. In an example embodiment, the method can include step 730 of sending from an initiating device A1 in a wireless network, a request to a forwarder device A4 in the network, to forward a delegated beacon based on beacon information of the initiating device A1, to a destination device A5 in the network and step 735 of forwarding from the forwarder wireless device A4 to the destination wireless device A5 the delegated beacon information. A delegated beacon is based on beacon information received from the initiating device, but whose format depends on the specific forwarding method used by the forwarder device. The initiating device A1 in FIG. 1A can send a request to device A4, as in FIGS. 5A and 5B, to forward delegated beacon information to device A5, as in FIGS. 5C and 5D, where an obstruction prevents transmissions in either direction between device A1 and device A5. Where the obstruction prevents transmissions from device A5 to be received by device A1, device A5 can mirror the steps in its reply by sending a request to device A4 to forward delegated beacon information to device A1, as in FIGS. 5E and 5F.

If the link between device A1 and device A5 is an asymmetric link only good for transmissions from A5 to A1, but not from A1 to A5, then the initiating device A1 in FIG. 6A can send a request to device A4 to forward delegated beacon information to device A5, as in FIG. 6B. But, if device A5 has the need to reply with a beacon to device A1, then device A5 can directly respond to device A1 with A5's own beacon, as in FIG. 6C. The steps of the method represented by the flow diagram of FIG. 8 can, for example, be performed under control of the medium access control (MAC) layer 2. The medium access control (MAC) layer 2, for example, can be a sub-layer of a Data Link layer of the WiMedia Ultra-Wideband (UWB) Common Radio Platform.

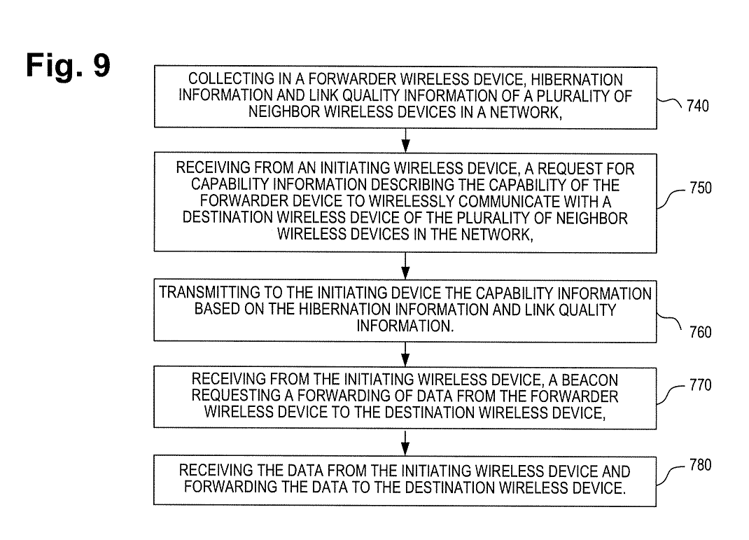

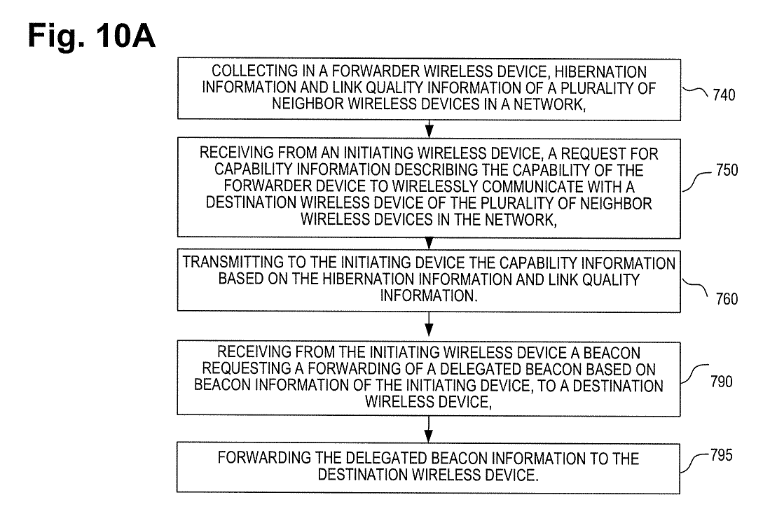

FIG. 9 is an example flow diagram of an example embodiment, for collecting hibernation information and link quality information such as by device A4 of FIG. A1, of a plurality of neighbor wireless devices in a network. The flow diagram can be embodied as program logic stored in the RAM 62 and/or ROM 64 in the form of sequences of programmed instructions which, when executed in the CPU 60, carry out the functions of the disclosed embodiments. In an example embodiment, the method includes step 740 of collecting in a first wireless device such as device A4, hibernation information and link quality information of a plurality of neighbor wireless device in a network, step 750 of receiving from a second wireless device such as device A1, a request for capability information describing the capability of the first device A4 to wirelessly communicate with a third wireless device such as device A5 of the plurality of neighbor wireless devices in the network, and step 760 of device A4 transmitting to the second device A1 the capability information based on the hibernation information and link quality information. Step 770 receives from the second wireless device A1, a beacon requesting a forwarding of data from the second wireless device A1 to the third wireless device A5. In step 780, device A4 receives the data from the second wireless device A1 and forwards the data to the third wireless device A5. The steps of the method represented by the flow diagram of FIG. 9 can, for example, be performed under control of the medium access control (MAC) layer 2. The medium access control (MAC) layer 2, for example, can be a sub-layer of a Data Link layer of the WiMedia Ultra-Wideband (UWB) Common Radio Platform.

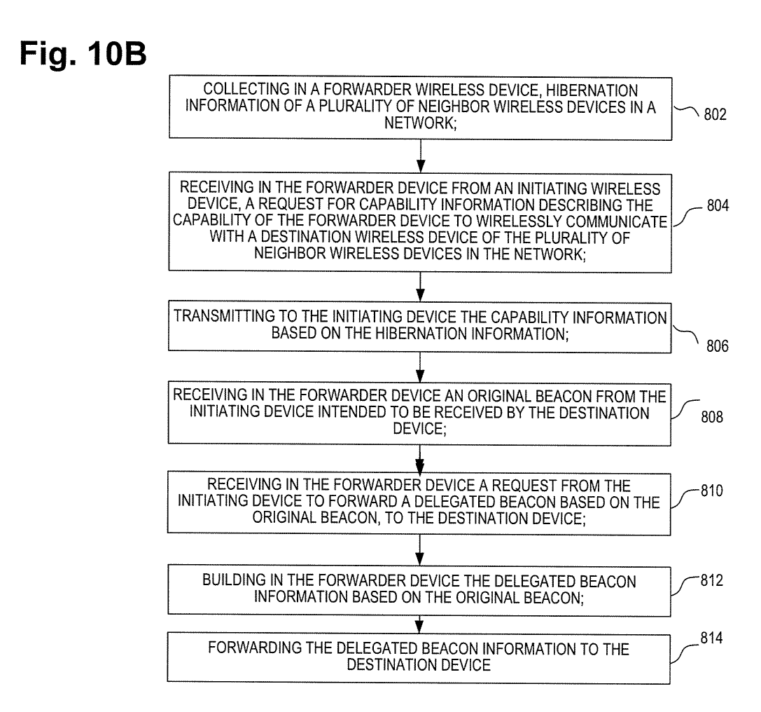

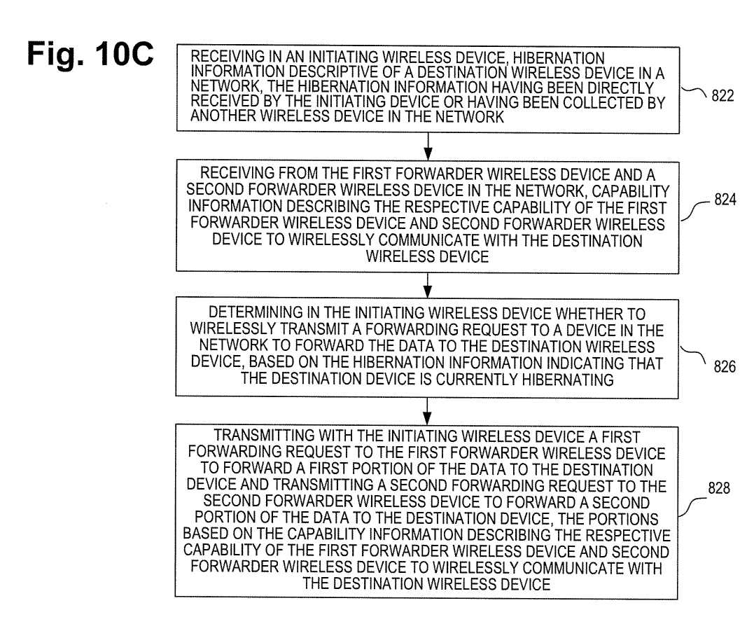

FIG. 10A is an example flow diagram of an example embodiment, for receiving a beacon including a delegated beacon request of a device, requesting a forwarding of delegated beacon information. The flow diagram can be embodied as program logic stored in the RAM 62 and/or ROM 64 in the form of sequences of programmed instructions which, when executed in the CPU 60, carry out the functions of the disclosed embodiments. The method includes steps 740, 750, and 760 from the flow diagram of FIG. 9. The method further includes the step 790 of receiving from the initiating wireless device A1 a beacon requesting a forwarding of a delegated beacon based on beacon information of the initiating device A1, to a destination wireless device A5, and step 795 of forwarding the delegated beacon information to the destination wireless device A5. The steps of the method represented by the flow diagram of FIG. 10A can, for example, be performed under control of the medium access control (MAC) layer 2. The medium access control (MAC) layer 2, for example, can be a sub-layer of a Data Link layer of the WiMedia Ultra-Wideband (UWB) Common Radio Platform.

FIG. 10B is an example flow diagram of an example embodiment, for receiving a request beacon requesting to forward a delegated beacon to be built by the forwarder device based on the original beacon received from the initiating device. The flow diagram can be embodied as program logic stored in the RAM 62 and/or ROM 64 in the form of sequences of programmed instructions which, when executed in the CPU 60, carry out the functions of the disclosed embodiments. The method further includes the step 802 of collecting in a forwarder wireless device A4, hibernation information of a plurality of neighbor wireless device in a network, including the device A5. The capability information can also include link quality (LQI), hibernation schedule, and reserve battery energy associated with the respective neighbor devices. Step 804 is receiving in the forwarder device A4 from an initiating wireless device A1, a request for capability information describing the capability of the forwarder device A4 to wirelessly communicate with a destination wireless device A5 of the plurality of neighbor wireless devices in the network. Step 806 is transmitting to the initiating device A1 the capability information based on the hibernation information. Step 808 is receiving in the forwarder device A4 an original beacon from the initiating device A1 intended to be received by the destination device A5. The destination device A5, in this example, does not receive the original beacon, either because it has been corrupted by interference or it is missed altogether. The initiating device A1 learns of the failure of the destination device A5 to receive the original beacon. Step 810 is receiving in the forwarder device A4 a request from the initiating device A1 to forward a delegated beacon based on the original beacon to the destination device A5. Step 812 is building in the forwarder device A4 delegated beacon information based on the original beacon. The forwarder device A4 proceeds to build the delegated beacon information based on the original beacon, but the delegated beacon may not include all of the original beacon fields. As discussed above, the size of the delegated beacon information is governed by the required or recommended information content needed for a properly functioning beacon that must accomplish its intended control or informational purpose at the destination device A5. Then, step 814 is forwarding the delegated beacon to the destination device A5.

FIG. 10C is an example flow diagram of an example embodiment, for load balancing in the forwarding process. The method includes the initiating device A1 distributing its forwarding request to several devices A3 and A4 in the beacon group, which are connected in both directions with the initiating device A1 and the destination device A5, to act as forwarder devices. The proportion of the forwarded traffic that the initiating device A1 allocates to each accepting delegated device A3 and A4 can be based, for example, on the link quality, buffer size, overlapped active time, residual battery energy, or other factor that each respective forwarder device A3 and A4 reports as its capability to forward information to the destination device A5. The flow diagram can be embodied as program logic stored in the RAM 62 and/or ROM 64 in the form of sequences of programmed instructions which, when executed in the CPU 60, carry out the functions of the disclosed embodiments. The method includes the step 822 of receiving in an initiating wireless device A1, hibernation information descriptive of a destination wireless device A5 in a network, the hibernation information having been directly received by the initiating device A1 or having been collected by another wireless device, such as device A4, in the network. Step 824 is receiving from the first forwarder wireless device A3 and a second forwarder wireless device A4 in the network, capability information describing the respective capability of the first forwarder wireless device A3 and second forwarder wireless device A4 to wirelessly communicate with the destination wireless device A5. Step 826 is determining in the initiating wireless device A1 whether to wirelessly transmit a forwarding request to a device in the network to forward the data to the destination wireless device A5, based on the hibernation information indicating that the destination device A5 is currently hibernating. Step 828 is transmitting with the initiating wireless device A1 a first forwarding request to the first forwarder wireless device A3 to forward a first portion of the data to the destination device A3 and transmitting a second forwarding request to the second forwarder wireless device A4 to forward a second portion of the data to the destination device A5, the portions based on the capability information describing the respective capability of the first forwarder wireless device A3 and second forwarder wireless device A4 to wirelessly communicate with the destination wireless device A5.

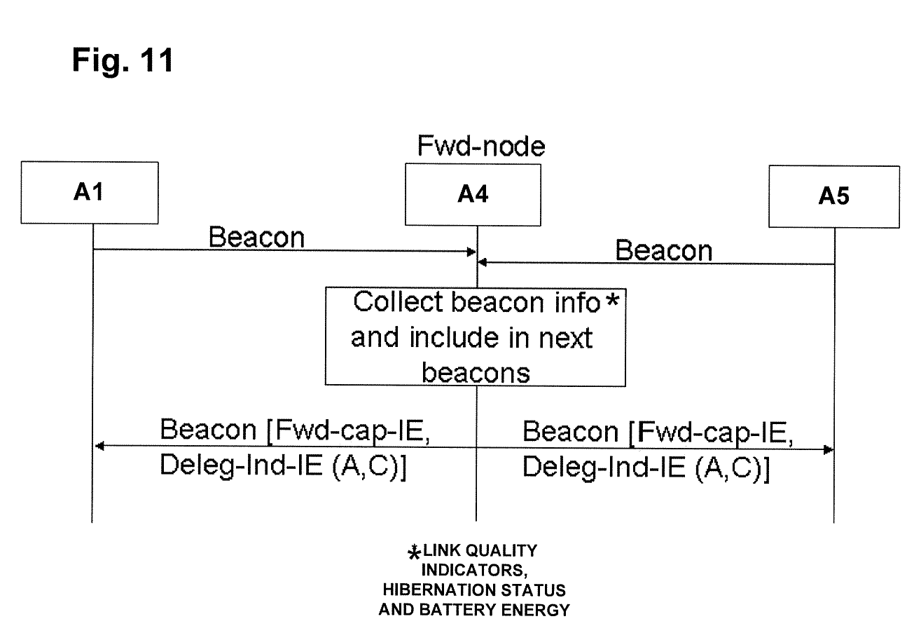

FIG. 11 is an example sequence diagram of an example embodiment, for a forwarding-capable device, such as device A4 of FIG. 1A, to automatically collect its neighbor's link quality indicators and hibernation status from their respective beacons from devices A1 and A5 and to broadcast the Forwarding Capability IE as in FIGS. 3A, 3B, and 3C and/or a Delegating Indication IE in its beacons to all of the devices in the beacon group, such as devices A1 and A5.

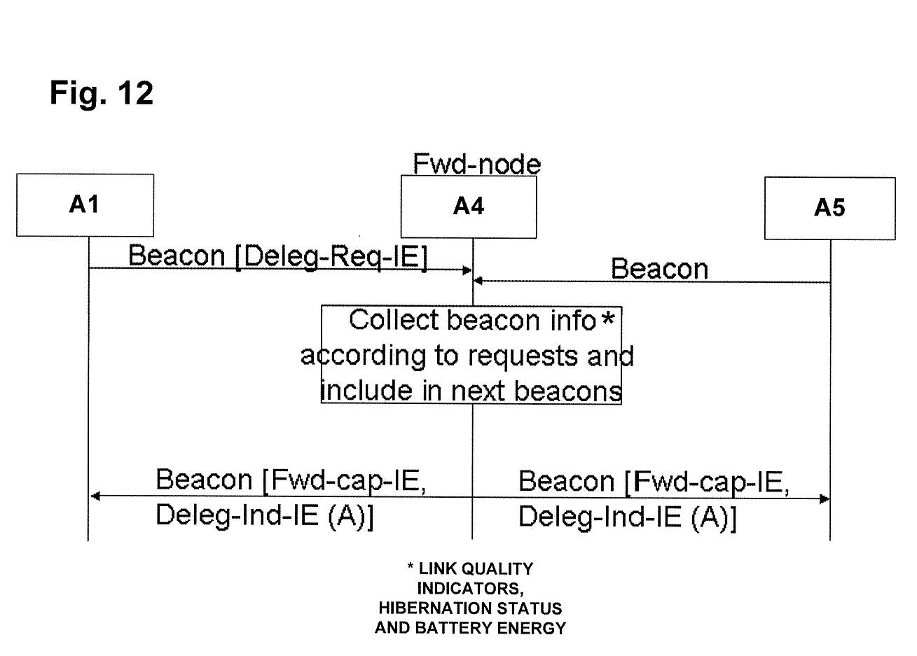

FIG. 12 is an example sequence diagram of an example embodiment, for a forwarding-capable device, such as device A4 of FIG. 1A, to collect its neighbor's link quality indicators and hibernation status from their respective beacons on request from device A1, in response to a Forwarding Request IE such as in FIGS. 2A, 2B, and 2C from device A1 and to broadcast the Forwarding Capability IE as in FIGS. 3A, 3B, and 3C and/or a Delegating Indication IE in its beacons to all of the devices in the group, including the requesting device A1.

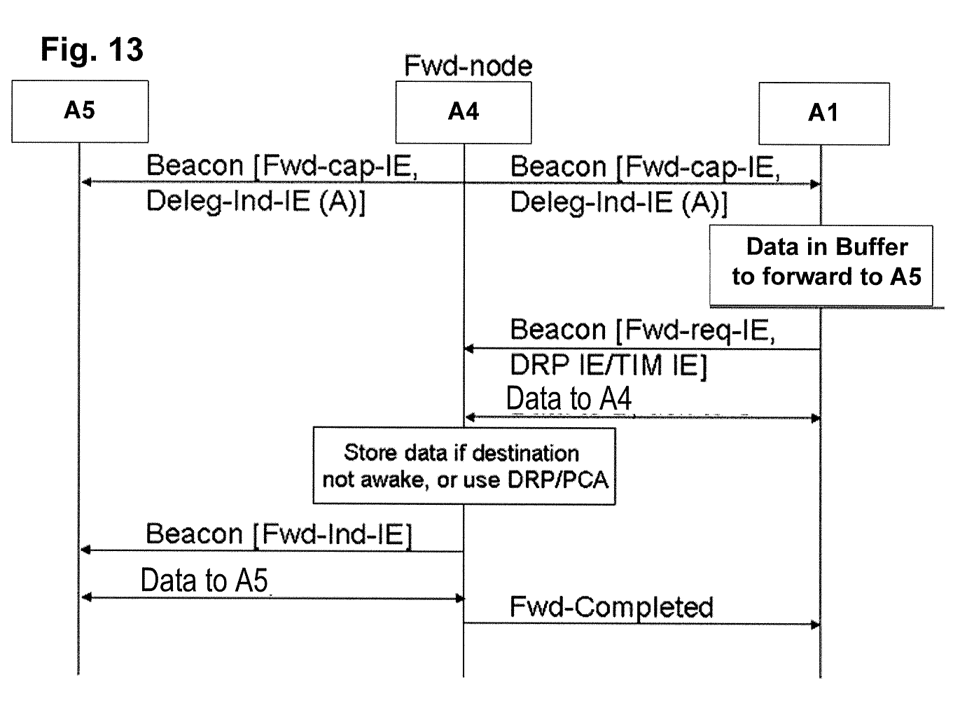

FIG. 13 is an example sequence diagram of an example embodiment, where device A1 recognizes that the device A5 is reachable by forwarding data over device A4. Device A1 sends a request, such as in FIG. 2A, to device A4 to forward the data and it also transmits the actual data in the data transfer period. Device A4 sends data to device A5, when A5 becomes available. Finally, device A4 reports when the task is completed.

### CONCLUSION

The resulting embodiments of the invention are implemented in the MAC sub-layer, they provide a more efficient and prompt method for forwarding data to devices that are currently in hibernation mode or are otherwise not reachable by the initiating device. The device embodiments of the invention have a reduced complexity, since there are no network layer routing tables required and there is less protocol overhead. Moreover, the embodiments of the invention consider explicitly the case of hibernating destinations and the case of dynamic topology due to changing link conditions.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention. For instance, the features described herein may be employed in networks other than WiMedia networks.

What is claimed is:

1. A method, comprising:
receiving information from a wireless device including an indication of said wireless device's capability to forward data within a network, said information further including descriptive information regarding at least one other wireless device in the network accessible through the wireless device; and
determining whether to wirelessly transmit data to said wireless device, for forwarding said data to the at least one other wireless device based on said received information.

2. The method of claim 1, further comprising:
said information being hibernation information descriptive of the at least one other wireless device.

3. The method of claim 2, further comprising:
said information being hibernation information wirelessly received from an information collecting device in the network.

4. The method of claim 2, further comprising:
said determining being performed by an initiating device, as to whether to wirelessly transmit data from said initiating device to said wireless device, for wirelessly forwarding said data to a destination device, based on said hibernation information indicating that said destination device is currently hibernating.

5. The method of claim 4, further comprising:
receiving in said initiating device, link quality information descriptive of said destination device; and
determining whether to send data from said initiating device to said wireless device, for wirelessly forwarding the data to the destination device, based on the link quality information.

6. The method of claim 4, further comprising:
wirelessly transmitting a beacon from said initiating device to said wireless device, said beacon requesting wireless forwarding of said data to the destination device.

7. The method of claim 4, further comprising:
wirelessly receiving in the initiating device, hibernation information descriptive of both the destination device and the wireless device; and
determining whether to wirelessly transmit data from said initiating device to the wireless device in the network, for forwarding the data to the destination device, based on the hibernation information indicating that said destination device is currently hibernating and that said wireless device is currently not hibernating.

8. The method of claim 7, further comprising:
wirelessly transmitting a request beacon from said initiating device to said wireless device, said request beacon requesting wirelessly forwarding of the data to the destination device.

9. The method of claim 7, further comprising:
wirelessly transmitting a request beacon from said initiating device to said wireless device, requesting the wireless device to build delegated beacon information based on a beacon wirelessly received from said initiating device and wirelessly forward the delegated beacon information to the destination device.

10. The method of claim 7, further comprising:
said wireless device collecting said hibernation information of the at least one other wireless device.

11. The method of claim 7, further comprising:
said initiating device wirelessly receiving said hibernation information from an information collecting device in the network.

12. An apparatus, comprising:
a memory configured to receive information from a wireless device including an indication of said wireless device's capability as a forwarder device to forward data within a network, said information further including descriptive information regarding at least one other wireless device in the network accessible through the wireless device; and
a processor coupled to the memory, configured to determine whether to wirelessly transmit data to said wireless device, for wirelessly forwarding said data to the at least one other wireless device based on said received information.

13. The apparatus of claim 12, further comprising:
said information being hibernation information descriptive of the at least one other wireless device.

14. The apparatus of claim 12, further comprising:
said information being hibernation information wirelessly received from an information collecting device in the network.

15. The apparatus of claim 14, further comprising:
said processor being in an initiating device, determining whether to wirelessly transmit data from said initiating device to said wireless device, for wirelessly forwarding said data to a destination device, based on said hibernation information indicating that said destination device is currently hibernating.

16. A method, comprising:
transmitting, by a wireless device, a beacon message during a dedicated portion of a repeating time period allocated for beacon transmissions for maintaining coordination with one or more other wireless devices within a network, wherein the beacon message includes an indication of said wireless device's capability to forward data within the network.

17. The method of claim 16, further comprising:
said indication including hibernation information.

18. The method of claim 17, further comprising:
wirelessly receiving from an initiating device, a request for capability information describing the capability of said wireless device to wirelessly communicate with a destination device of said one or more other wireless devices.

19. The method of claim 18, further comprising:
wirelessly transmitting to said initiating device said capability information based on said hibernation information.

20. The method of claim 19, further comprising:
wirelessly receiving from the initiating device, a beacon requesting a wireless forwarding of data from said initiating device to the destination device; and
wirelessly receiving the data from the initiating device and wirelessly forwarding the data to the destination device.

21. The method of claim 19, further comprising:
wirelessly receiving from the initiating device a request beacon requesting building delegated beacon information based on a beacon wirelessly received from said initiating device; and
wirelessly forwarding said delegated beacon information to the destination device.

22. An apparatus, comprising:
a transmitter in a wireless device, configured to transmit a beacon message during a dedicated portion of a repeating time period allocated for beacon transmissions in a network;
a processor coupled to said transmitter, configured to maintain coordination with one or more other wireless devices within the network;
wherein the beacon message includes an indication of said wireless device's capability to forward said information within the network.

23. The apparatus of claim 22, further comprising:
a receiver coupled to the processor, configured to wirelessly receive from an initiating device, a request for capability information describing said capability to wirelessly communicate with a destination device of the one or more other wireless devices in the network.

24. The apparatus of claim 23, further comprising:
said capability information including hibernation information.

25. The apparatus of claim 23, further comprising:
said receiver configured to wirelessly receive from the initiating device, a beacon requesting a wireless forwarding of data from said initiating device to the destination device; and
said receiver configured to wirelessly receive the data from the initiating device and wirelessly forward the data to the destination device.

26. The apparatus of claim 23, further comprising:
said receiver configured to wirelessly receive from the initiating device a request beacon requesting building delegated beacon information based on a beacon wirelessly received from said initiating device, said request beacon requesting wirelessly forwarding the delegated beacon information to the destination device; and
said processor configured to forward said delegated beacon information to the destination device.

27. A computer program product, comprising:
a computer readable medium having computer program code therein;
program code in said computer readable medium, for receiving information from a wireless device including an indication of said wireless device's capability to forward data within a network, said information further including descriptive information regarding at least one other wireless device in the network accessible through the wireless device; and
program code in said computer readable medium, for determining whether to wirelessly transmit data to said wireless device, for forwarding said data to the at least one other wireless device based on said received information.

28. A computer program product, comprising:
a computer readable medium having computer program code therein;
program code in said computer readable medium, for transmitting, by a wireless device, a beacon message during a dedicated portion of a repeating time period allocated for beacon transmissions for maintaining coordination with one or more other wireless devices within a network, wherein the beacon message includes an indication of said wireless device's capability to forward data within the network.

29. An apparatus, comprising:
means for receiving information from a wireless device including an indication of said wireless device's capability to forward data within a network, said information further including descriptive information regarding at least one other wireless device in the network accessible through the wireless device; and
means for determining whether to wirelessly transmit data to said wireless device, for forwarding said data to the at least one other wireless device based on said received information.

30. An apparatus, comprising:
means for transmitting a beacon message during a dedicated portion of a repeating time period allocated for beacon transmissions in a network; and
means for maintaining coordination with one or more other wireless devices within the network;
wherein the beacon message includes an indication of said wireless device's capability to forward said information within the network.

31. A system, comprising:
a forwarder wireless device, configured to transmit a beacon message during a dedicated portion of a repeating time period allocated for beacon transmissions in a network to maintain coordination with one or more other wireless devices within the network;
an initiating wireless device configured to receive from said forwarder device, capability information describing the capability of said forwarder device to wirelessly communicate with a destination wireless device of the one or more other wireless devices in the network;
said initiating device configured to transmit data to said forwarder device, for forwarding said data to said destination wireless device, based on said capability information.

32. An apparatus, comprising:
a processor in an initiating device configured to prepare a request to a forwarder wireless device in the network, requesting the forwarder device to build delegated beacon information based on a beacon received from said initiating device and forward the delegated beacon information to a destination wireless device; and
a transmitter coupled to said processor, configured to transmit to said forwarder device said request.

33. A computer program product, comprising:
a computer readable medium having computer program code therein;
program code in said computer readable medium, for preparing a request in an initiating wireless device to send to a forwarder wireless device in the network, requesting the forwarder device to build delegated beacon information based on a beacon received from said initiating device and forward the delegated beacon information to a destination wireless device; and
program code in said computer readable medium, for transmitting to said forwarder device said request.

34. The computer program product of claim 33, further comprising:
program code in said computer readable medium, for receiving in said initiating wireless device, residual energy information descriptive of said forwarder wireless device; and
program code in said computer readable medium, for determining whether to send data from said initiating device to said forwarder wireless device, for forwarding the data to the destination wireless device, based on the residual energy information.

35. A method, comprising:
collecting in a forwarder wireless device, hibernation information of a plurality of neighbor wireless device in a network;
receiving in the forwarder device from an initiating wireless device, a request for capability information describing the capability of said forwarder device to wirelessly communicate with a destination wireless device of the plurality of neighbor wireless devices in the network;
transmitting to said initiating device said capability information based on said hibernation information;
receiving in the forwarder device an original beacon from said initiating device intended to be received by said destination device;
receiving in the forwarder device a request from said initiating device to forward a delegated beacon based on said original beacon to said destination device;
building in the forwarder device delegated beacon information based on said original beacon; and
forwarding said delegated beacon information to said destination device.

36. The method of claim 35, wherein said delegated beacon information is sent in a beacon slot currently assigned to the forwarder device.

37. The method of claim 35, wherein said delegated beacon information is sent in a second beacon slot of two beacon slots assigned to the forwarder device.

38. The method of claim 35, wherein said delegated beacon information is sent in a data transfer period reserved by the forwarder device.

39. The method of claim 35, wherein said capability information includes a link quality (LQI) with said destination device.

40. The method of claim 35, wherein said capability information includes overlapped active time with said destination device.

41. The method of claim 35, wherein said capability information includes residual energy information.
